(19) United States
(12) Patent Application Publication
(10) Pub. No.: US 2018/0066131 A1
(43) Pub. Date: Mar. 8, 2018

(54) POLYMER NANOPARTICLE THERMAL INSULATORS

(71) Applicant: NanoSD Inc., San Diego, CA (US)

(72) Inventors: Sungho Jin, San Diego, CA (US); Gunwoo Kim, San Diego, CA (US); Chulmin Choi, San Diego, CA (US); Youngjin Kim, San Diego, CA (US); Kyuin Park, San Diego, CA (US)

(21) Appl. No.: 15/811,253

(22) Filed: Nov. 13, 2017

Related U.S. Application Data
(63) Continuation of application No. PCT/US2017/050130, filed on Sep. 5, 2017.
(60) Provisional application No. 62/383,564, filed on Sep. 5, 2016.
(60) Provisional application No. 62/413,522, filed on Oct. 27, 2016.
(60) Provisional application No. 62/470,274, filed on Mar. 12, 2017.
(60) Provisional application No. 62/535,866, filed on Jul. 22, 2017.

(51) Int. Cl. C08L 25/06; C08L 33/12; C08J 9/228

(52) U.S. Cl. CPC C08L 25/06; C08L 33/12; C08J 9/228; C08L 2201/08; C08L 2201/06; C08L 2201/10; C08J 2325/06; C08J 2333/12; C08L 2205/20

(57) ABSTRACT

A thermally insulating article is provided which includes a subdivided, non-periodically arranged, amorphous-array-structured polymer particle assembly, wherein the article has a thermal conductivity of less than about 0.10 watt/m·K. The article can be used for many purposes, including attaching to an exterior window to reduce energy loss through the window.

### CROSS-REFERENCE TO RELATED APPLICATIONS

This application is a continuation of PCT Application No. PCT/US17/50130 filed on Sep. 5, 2017, which claims the priority benefit of U.S. Provisional Patent Application No. 62/383,564, filed on Sep. 5, 2016; U.S. Provisional Patent Application No. 62/413,522, filed on Oct. 27, 2016; U.S. Provisional Patent Application No. 62/470,274, filed on Mar. 12, 2017; and U.S. Provisional Patent Application No. 62/535,866, filed on Jul. 22, 2017.

### GOVERNMENT SUPPORT

This disclosure was made with government support under grant DE-AR0000744 awarded by the U.S. Department of Energy's Advanced Research Projections Agency-Energy (ARPA-E). The government has certain rights in the invention.

### FIELD

The present invention relates generally to thermally insulating nanostructures and, more specifically, for their use on building envelopes, apparel items, and other applications.

### BACKGROUND

Thermal insulation materials are important for many engineering applications such as buildings, homes, automobiles, refrigerators, transportation vehicles, electronic devices, and apparel to keep a person warm. Buildings in the United States consume a significant amount of energy to regulate the indoor temperature using heating, ventilation and air conditioning (HVAC) systems. See for e.g.: L. Perez-Lombard et al., Energ. Buildings (2008); D. H. Li et al., Build. Environ. (2014); L. Malys et al., Build. Environ., (2014); Sawyer, K. (editor), “Windows and Building Envelope Research and Development: Roadmap for Emerging Technologies,” Building Technologies Office, EERE, U.S. Department of Energy (2014).

Heat loss through glass windows in cold weather across the U.S., especially from single-pane windows, amounts to a significant portion of primary energy consumption. Current technology for insulating windows include use of a double-pane type insulated glass unit (IGU), with a low-emissivity (low-e) coating on one of the surfaces. See for e.g.: Muneer, T, et al., Windows in Buildings: Thermal, Acoustic, Visual and Solar Performance (Architectural Press, 2000); 2011 Buildings Energy Databook, Tables 5.2.5 and 5.2.7. U.S. Department of Energy, Office of Energy Efficiency and Renewable Energy. Low-e window films can be applied to the interior surface of a window pane using adhesive means, so as to modify the optical properties of existing windows in buildings, homes and automobiles thereby minimizing emission loss of IR radiation. However, interior surface condensation resistance is sacrificed by the low-e layer. See for e.g.: Wright, J. L. (2014). “The use of surface indoor low-e coatings: The implications regarding condensation resistance”, presented at the ARPA-E Workshop on Single-pane Window Efficiency (November, 2014). Such condensation can negatively affect the emissivity as well since water and ice are highly emissive.

Further, a hard-coat type low-e layer adds substantially to the cost of the single-pane insulating layer. While a commercially available low-e layer can simply be attached onto the surface of any new window structures, it is highly desirable if the low-e layer can also be added on to the insulating coating by inexpensive and easily scalable methods in a retrofit manner.

Potential energy savings by retrofitting single-pane glass windows with highly insulating layers could potentially save as much as $12 billion/year for US energy consumers.

### SUMMARY

Aspects of the present disclosure provide for energy saving materials having superior thermal insulating characteristics. Broadly speaking, the present disclosure provides a description of optically transparent and non-transparent, thermally insulating structures (for building and home windows, walls or other envelopes, as well as for general insulating applications), which can be grouped into near-periodically arranged structure and randomly (or amorphously) distributed structure of polymer nanoparticles.

In one aspect of the present disclosure, nanoscale subdivision of polymer materials is provided. To meet the need for a highly insulating and transparent material that can be added as retrofits onto existing single-pane glass windows, the choice of nanomaterials is one of the important factors. Highly porous nano silica (well known as “aerogel”), exhibits a low K value of 0.02 W/mK, but has rather fragile mechanical properties and unsatisfactory optical transparency including bluish haze. Polymers such as PMMA (acrylic) or PS (polystyrene) exhibit a generally lower thermal conductivity (e.g., K˜0.18 W/mK), which exhibit ˜8 times lower K value than that for silica (K=˜1.4 W/mK). PS type polymers are much lighter in weight, thus polymer structures with designed nanoscale air porosity like nano-bubble structure, can provide highly desirable low K of e.g., ˜0.03 W/mK with a corresponding low U-factor and in the meantime possess a much lower porosity and hence are more robust compared to silica aerogel.

Aspects of the present disclosure are based on either periodically or randomly arranged polymer nanobubble and polymer nanoparticle structures, enabling scalable, low-cost manufacturing. According to aspects of the present disclosure, structural dimensions of polymer are selected to be of a much smaller, nanobubble configuration, with the size scale chosen to be in the deep-subwavelength regime to minimize the haze effect.

For efficient thermal insulation for glass windows, the desirable winter U-factor should be less than 0.50 BTU/sf/hr/° F., corresponding to the thermal conductivity requirement of K<0.05 W/mK. In order to achieve such a low thermal conductivity, it is desirable to avoid a relatively high thermal conductivity material such as silica (K˜1.4 W/mK), unless extremely small volume fraction is utilized with corresponding fragile mechanical characteristics. Therefore, it is desirable to start with a lower K material such as a polymer. Considering that the K(polymer) is 0.18 W/mK and K(air) is 0.025 W/mK, obtaining a desirably low K value of e.g., <0.05 W/mK requires a reasonable combination of polymer material volume and air (or gas) trapped within, and needs a nano-dimension of polymer nanobubble structure to reduce the thermal conductivity of air by subdivision. Such a nanodivision, according to the present disclosure, simultaneously induces optical transparency due to the deep subwavelength dimensions.

The average nano dimension of the polymer nanobubbles or nanoparticles preferred according to the present disclosure is less than 100 nm, preferably less than 60 nm for the purpose of achieving optically transparent insulators. For different applications of simple, efficient thermal insulators without the stringent requirements of optical transparency and the haze-less materials, the polymer structure dimension can be extended to micrometer scales.

In another aspect, a thermally insulating article comprising a subdivided, non-periodically arranged, amorphous-array-structured polymer particle assembly is provided. The article has a thermal conductivity of less than about 0.10 watt/m·K. In embodiments, the thermal conductivity is less than about 0.05 watt/m·K. In embodiments, the thermal conductivity is less than about 0.03 watt/m·K. In embodiments, the polymer assembly has a subdivision dimension in the range of about 10 nm to about 10 μm. In embodiments, the polymer assembly has a subdivision dimension in the range of about 10 nm to about 2 μm. In embodiments, the polymer assembly has a subdivision dimension in the range of about 10 nm-100 nm. In embodiments, the amorphous-array-structure is comprised of a non-uniform diameter polymer particle assembly, with a desired porosity of at least 30%, or at least 45%, or at least 60%. In embodiments, the article is comprised of an irregular shape polymer particle assembly, with a desired porosity of at least 30%, or at least 45%, or at least 60%. In embodiments, the polymer is selected from polymethylmethacrylate (PMMA), polyethylene terephthalate (PET), polystyrene (PS), polypropylene (PP), polyester (PES), polyethylene (PR), polytetrafluoroethylene (PTFE), polydimethylsiloxane (PDMS), polyvinylidene fluoride (PVDF), polyethylene naphthalate (PEN), polybutylene terephthalate (PBT), a co-polymer thereof, or any combinations thereof. In embodiments, the article has an optical transparency of at least about 70%, at least about 80%, or at least about 90%. In embodiments, the article has an optical haze property of at most about 10%, at most about 5%, or at most about 2%. In embodiments, the polymer particle assembly contains two or more internal pores. In embodiments, the internal pores have a size range of about 1 to about 50 nm. In embodiments, the internal pores are filled with a gas to lower thermal conductivity. In embodiments, the gas is CO₂ gas. In embodiments, the thermal conductivity is lowered by at least 10% compared to an article having pores filled solely with air. In embodiments, the polymer particle assembly comprises an environmentally degradable nano or micro subdivided polymer insulator material. In embodiments, the article has an optical transparency of at least about 70%, at least about 80%, or at least about 90%. In embodiments, the article has an optical haze scattering property of less than about 10%, less than about 5%, or less than about 2%. In embodiments, the article has an optical transparency of at least about 70%, at least about 80%, or at least about 90% and an optical haze scattering property of less than about 10%, less than about 5%, or less than about 2%. In embodiments, the polymer particle assembly further contains a UV protection or absorption coating. In embodiments, the polymer particle assembly further contains a wear-resistant coating. In embodiments, the wear-resistant coating comprises ceramic nanoparticles. In embodiments, the polymer particle assembly further contains an adhesive layer. In another aspect of the present disclosure, use of the article described herein is made to minimize loss of energy through a glass window.

### BRIEF DESCRIPTION OF THE DRAWINGS

The nature, advantages and various additional features of the invention will appear more fully upon consideration of the illustrative embodiments now to be described in detail with the accompanying drawings. In the drawings:

FIGS. 1A through 1C depict hollow polymer nanospheres stacked into a densely packed layer and sintered to form a nano-bubble structure. FIG. 1D depicts an example of hollow polystyrene nanospheres (˜70 nm dia; 3 nm wall).

FIGS. 2A through 2D depict polymer nanospheres of PMMA or PS, ˜60 nm size regime, being produced, densely packed, and infiltrated with another polymer such as PUA, followed by selective etch-away of nanospheres to create nanoscale inverse-opal structure with periodic void array. FIG. 2E depicts an example of an inverse opal structure. FIG. 2F depicts an example of a near-periodic, high density stacking of ˜60 nm polystyrene nanospheres, which can serve as the basis for formation of nano inverse opal structure.

FIG. 3. depicts a cross-sectional diagram of a polymer nanobubble structure prepared by pressing and sintering monodisperse hollow polymer spheres.

FIG. 4 depicts the reduction of air thermal conductivity (K) by subdivision of air volume.

FIG. 5A depicts a basic electrospray configuration illustrating Taylor cone formation and coulombic fission to emit a jet of liquid drops under high voltage. FIG. 5B depicts an example of a “Discrete Electro Spray” electrode, with only the patterned island regions made conducive to droplet formation. FIG. 5C depicts a schematic of a device that generates a continuous discrete electro spray for high-speed droplet formation.

FIG. 6. depicts a Discrete Electro Spray device that contains an array of nanochannels for monodisperse polymer nanosphere synthesis.

FIG. 7A depicts a schematic of centrifugal packing/drying for higher density nanoparticles. FIG. 7B depicts an example of a centrifuge dry machine. FIG. 7C depicts a SEM micrograph of silica NPs dried without centrifugal force showing many stacking defects. FIG. 7D depicts a SEM of polystyrene NPs (with sodium dodecyl sulfate (SD S) anionic surfactant) dried at 4,000 rpm centrifugal force exhibiting high-density packing with minimal stacking defects.

FIG. 8 depicts an example of a method of continuous and sequential dip coating of polymer nanospheres into dense stacking.

FIG. 9 depicts an example of a roller compacting technique for densifying stacked polymer nanospheres (hollow or solid), optionally with simultaneous sintering accomplished.

FIG. 10 depicts an example of a method of a continuous “Electro-Stacking” technique that uses electrical-field-actuated, densely packed stacking of hollow (or dense) nanospheres with minimal defects.

FIG. 11A depicts surfactant-assisted evaporation drying of nanospheres with a continuous spray, stacking, and drying process. FIG. 11B depicts a SEM micrograph of aligned and stacked PS nanospheres after a surfactant-assisted evaporation drying of nanospheres.

FIG. 12 depicts rising air bubble stacking in viscous polymer solution and curing for porous polymer synthesis.

FIG. 13A depicts a schematic of electrolytic stacking of charged polymer nanoparticles (e.g., coated with ionic surfactant) into a thick insulator layer in a liquid bath. FIG. 13B depicts an experimental demonstration of electrolytic stacking of polystyrene (PS) nanoparticles (˜50 nm size) on a Cu cathode.

FIG. 14. depicts an nanoporous polymer synthesis by phase separation approach in diblock or triblock co-polymer.

FIG. 15A depicts an example of a method for nano spray pyrolysis to produce hollow or solid polymer spheres in nano dimension using DES-controlled mist generation or nano-mist technology in general. FIG. 15B depicts an example of DES sprayer incorporated spray pyrolysis.

FIG. 15C depicts a nano patterned surface to aid in more efficient nano-mist creation in piezoelectric nebulizer devices. FIG. 15D depicts an exemplary spray pyrolysis apparatus. FIG. 15E depicts an example of essentially monodisperse, 90 nm diameter PMMA polymer nanospheres synthesized by spray pyrolysis.

FIG. 16A. depicts control of polymer nanoparticle structures for reduced thermal conductivity and reduced optical haze. The left panel of FIG. 16A depicts a standard periodic, close-packed nanosphere array. The top right panel of FIG. 16A depicts an example of intentionally made random, non-periodic (also termed “amorphous array” structured) nanoparticle polymer assembly by avoiding mono-disperse particle diameter and using non-uniform diameter nanospheres for stacking. The bottom right panel of FIG. 16A depicts an example of intentionally made irregular shaped (non-spherical) nanoparticles. FIG. 16B depicts internal pores added into inside of polymer nanoparticles for additional porosity, reduced thermal conductivity and enhanced optical transparency. The left panel of the figure depicts spherical uniform-diameter particles. The top right panel of the figure depicts spherical and non-uniform-diameter particles but with one or more internal pores. The bottom right panel of the figure depicts irregular shaped particles with one or more internal pores. FIG. 16C depicts a schematic representation of exemplary irregular shaped polymer particles or their two dimensional projections useful for increased porosity in amorphous array structured particle assembly. The top panel of the figure depicts various examples of irregular shaped polymer particles. The bottom panel of the figure depicts examples of irregular polymer particles having one or more internal pores within the irregular polymer particles desirably further increase the porosity.

FIG. 17A depicts an example of a mechanically robust amorphous array of structured polymer nanoparticles which are physically connected, non-uniform diameter, amorphous structured nano spheres array, and which are non-periodic and more porous. FIG. 17B depicts an example of a mechanically more robust amorphous array of structured polymer nanoparticles which are physically connected irregular (or non-spherical) shaped nano particles array, which is non-periodic and more porous.

FIG. 18A depicts an example of an essentially periodic array of mostly equi-diameter nanospheres. FIG. 18B depicts an example of an amorphous and random array structure by non-uniform diameter polystyrene (PS) nanospheres which results in many point-defect-like defects or voids that can provide increased porosity and reduced thermal conductivity.

FIG. 19 depicts an example of a method of polystyrene nanosphere synthesis using a Micelle reaction (oil-in-water emulsion) using polymerization of styrene monomer with SDS (Sodium dodecyl sulfate) surfactant.

FIG. 20 depicts an example of a method to obtain a close packed nanosphere stacking, by surfactant induced evaporative deposition using SDS (sodium dodecyl sulfate) surfactant on polystyrene nanospheres (˜67 nm dia).

FIG. 21A depicts a low magnification SEM micrograph that shows a polystyrene non-uniform particle size distribution with amorphous array structure over a larger area. FIG. 21B depicts a SEM micrograph (taken at 45 degree tilt angle) that shows the thickness of the amorphous array structured nanoparticle film is ˜15-20 μm. FIG. 21C depicts optically transparent, polymer nanoparticle array layer samples on glass substrate. FIG. 21D depicts optical reflectivity of nanoparticle (NP) sample versus wavelength. FIG. 21E depicts a transparent polymer nanoparticle layer sample super-imposed on letterings to demonstrate the optical transparency.

FIGS. 22A and 22B depict comparative SEM micrographs of example polystyrene (PS) nanoparticle arrays. FIG. 22A depicts an essentially periodic array of mostly equi-diameter nanospheres, FIG. 22B depicts an amorphous and random array structure by adopting irregular shape PS nanoparticles, resulting in many small-sized pores which contribute to reducing the thermal conductivity while an optical haze effect is minimized.

FIG. 23 depicts a low magnification SEM micrograph that shows an amorphous array structure of ˜60 nm diameter PS nanoparticles with irregular (less spherical) particle shape distribution over a larger area.

FIGS. 24A and 24B depict thermal conductivity estimation. FIG. 24A depicts how subdivision of air (e.g., via the presence of small porosity) reduces the thermal conductivity of air. FIG. 24B depicts thermal conductivity vs. porosity curves (by calculation modeling) for various polymer nanoparticle and nanopore arrangements.

FIG. 25 depicts the effect of particle elongation aspect ratio L/D on porosity P. As the aspect ratio increases, the packing density is reduced and the porosity can be increased.

FIG. 26 depicts various examples of polymer nanoparticle elongation techniques. The top right panel of the figure depicts elongation by encapsulating the polymer particles within a plastically deformable capsule container followed by warm rolling to produce an elongated flake shape, then dissolving away the disposable matrix to retrieve the elongated particles. The bottom right panel of the figure depicts elongation by uniaxial deformation such as swaging or rod rolling (warm processing) to produce near-rod-like shaped particles, followed by removal of disposable matrix.

FIG. 27 depicts an example of a rectangular or cylindrical particle shape produced by an emulsion method. ˜70 nm irregular PS nanoparticles (porous, cylindrical or rectangle shapes) made to increase overall porosity and reduce thermal conductivity.

FIG. 28A depicts the synthesis of exemplary hollow-hole structured PS nanoparticles where both the non-uniform particle diameter and the presence of the internal voids contribute to the reduced thermal conductivity. For the exemplary microemulsion synthesis, a mix of Styrene:MMA:Tri Methylbenzene:DVB=3:3:5:1 mix ratio was employed. FIG. 28B depicts an example of non-uniform sized amorphous structured hollow-hole polystyrene (PS) nanoparticles, but with adjacent hollow particles advantageously bonded to each other.

FIG. 29 depicts an example of size-reduced polystyrene nanoparticles with sub-20 nm irregular sizes, synthesized by microemulsion technique using Styrene:Xylene:DVB (Divinylbenzene)=1:9:1 ratio.

FIG. 30 depicts a SEM micrograph of non-uniform diameter, amorphous structured polystyrene nanoparticles (˜60 nm size regime), with rather small size defects/voids. However, there are some large defects/voids of ˜200 nm or larger size, which need to be removed in order to obtain low haze, high transparency PS layers.

FIG. 31 depicts an example of a method to reduce the number of undesirably large (>100 nm) defects comprising rolling type deformation of the nanoparticle stack (having irregular diameter or irregular shape) to remove the larger, undesirable defects that can cause haze-type transparency reducing problems.

FIG. 32 depicts an example of a method to produce a polymer nanoparticle layer by multi-nozzle spray coating of irregular-shaped or size-varying 30˜60 nm PS or PMMA nanospheres in colloidal solution (with selected surfactant).

FIG. 33 depicts an alternative method of rapidly achieving a polymer nanoparticle layer accumulation by electrolytic stacking or electrophoretic deposition of charged polymer nanoparticles. The surface of the polymer nanoparticles such as PS (polystyrene), PEN or PMMA is altered, e.g., by surfactant ions (e.g., SDS), to have negative or positive surface charge. Applying electric field makes the charged particles to move to the opposite polarity electrode to form a thick layer.

FIG. 34 depicts an example of methods of preparing hollow polymer nanobubbles using sacrificial removable core, by using solid silica nanoparticles, and by using hollow silica nanoparticles as templates.

FIG. 35 depicts an example of a method for synthesis of hollow polystyrene polymer nanospheres using polymerization of MMA (methyl methacrlate) and styrene, then removing the PMMA.

FIG. 36 depicts an example of a method for synthesis of hollow polystyrene polymer (PS) nanospheres using a liquid core.

FIG. 37 depicts an example of an environmentally-friendly, intentionally degradable polymer nanobubbles. The left panel of the figure depicts environmentally-friendly, intentionally degradable polymer nanobubbles with dissolvable or degradable interface material; and the right panel of the figure depicts degraded and disintegrated structure after environmental exposure to air, soil, water, UV light, temperature change, etc.

FIG. 38 depicts various examples of nanospheres or irregular shape particles containing internal pores and their existence after being degraded by the environment. The top example details spherical, non-uniform diameter nanospheres that are non-period and more porous are depicted prior to being degraded by the environment and after being degraded by the environment. In the example below, irregular (or non-spherical) nanospheres that are non-periodic and more porous are depicted prior to being degraded by the environment and after being degraded by the environment.

FIG. 39A depicts an example of a retrofittably attachable, low K (thermal conductivity), low U-factor, thermal barrier, complemented with a low e2 coating and wear-resistant ceramic coating, transfer bonded by easily peelable carrier sheet coils. FIG. 39B depicts an example of a carrier sheet release, well known peelable silicone adhesives stable to close to ˜250° C. can be utilized. FIG. 39C depicts the transmission vs. the wavelength of ITO (indium-tin-oxide) layer dependent on carrier concentration. FIG. 39D depicts the optical transmission characteristics of new transparent, wear-resistant silica coating.

FIG. 40 depicts an example of multi-station, continuous manufacturing of a polymer nano-bubble layer with low-emission coating incorporated using one-series operation, to enable a low cost production.

It is to be understood that the drawings are for purposes of illustrating the concepts of the invention and are not to scale.

### DETAILED DESCRIPTION

### Definitions and Interpretation

The following description is of various exemplary embodiments only, and is not intended to limit the scope, applicability or configuration of the present disclosure in any way. Rather, the following description is intended to provide a convenient illustration for implementing various embodiments including the best mode. As will become apparent, various changes may be made in the function and arrangement of the elements described in these embodiments without departing from principles of the present disclosure.

Unless defined otherwise, all technical and scientific terms used herein have the same meaning as commonly understood by those of ordinary skill in the art to which the disclosure belongs. Although any methods and materials similar or equivalent to those described herein can be used in the practice or testing of the subject matter of the present disclosure, preferred methods and materials are described. For the purposes of the present disclosure, the following terms are defined below.

The articles “a” and “an” are used herein to refer to one or to more than one (i.e., to at least one) of the grammatical object of the article. By way of example, “an element” means one element or more than one element.

The term “about” means a quantity, level, value, number, frequency, percentage, dimension, size, amount, weight or length that varies by as much as 30, 25, 20, 15, 10, 9, 8, 7, 6, 5, 4, 3, 2 or 1% to a reference quantity, level, value, number, frequency, percentage, dimension, size, amount, weight or length.

Throughout this disclosure, unless the context requires otherwise, the words “comprise,” “comprises,” and “comprising” will be understood to imply the inclusion of a stated step or element or group of steps or elements but not the exclusion of any other step or element or group of steps or elements.

As may be used herein, the term “consisting of” means including, and limited to, whatever follows the phrase “consisting of.” Thus, the phrase “consisting of” indicates that the listed elements are required or mandatory, and that no other elements may be present. The term “consisting essentially of” means including any elements listed after the phrase, and limited to other elements that do not interfere with or contribute to the activity or action specified in the disclosure for the listed elements. Thus, the phrase “consisting essentially of” indicates that the listed elements are required or mandatory, but that other elements are optional and may or may not be present depending upon whether or not they materially affect the activity or action of the listed elements.

### DESCRIPTION OF EMBODIMENTS

The present disclosure describes various embodiments of new materials and structures related to thermally insulating structures for use on building envelopes, vehicles, electronic devices, food product storage and transportation, and apparels, among other things. Various inventions and embodiments are described in this patent application, as listed and described below. The broad category of the present disclosure relates to optically transparent or non-transparent, thermally insulating structures (for building and home windows, walls or other envelopes, as well as for general insulating applications), can be grouped into two types of embodiments of uniquely nanoscale-subdivided polymer assembly structures having, (i) near-spherical hollow nanobubble polymers with periodically or non-periodically arranged geometries, (ii) intentionally non-spherical, non-uniform-sized polymer nanoparticle or nanobubble polymers. The average nano dimension of the polymer nanobubbles or nanoparticles preferred in this disclosure is less than 100 nm, preferably less than 60 nm for the purpose of achieving optically transparent insulators. For different applications of simple, efficient thermal insulators without the stringent requirements of optical transparency and the haze-less materials, the polymer structure dimension in this disclosure can be extended to micrometer scales.

Another important aspect of the present disclosure is environmental friendliness. Good thermal insulating polymers such as expanded polystyrene polymers (well known as Styrofoam) have been widely used for hot coffee cups, take-out food containers, and packing/shipping filler materials. The long-lasting stability of styrofoam microbubble insulators is of concern because of environmental and health concerns of styrofoam, thus its use is banned in many cities. To meet such challenges, the present disclosure also discloses novel structured “degradable or biodegradable insulators” based on various polymer nanoconfiguration materials.

Several variations of exemplary embodiment structures of the present disclosure are described as follows. The present disclosure details polymer nanobubble structured thermal insulators, having either periodic or amorphous particle arrangements.

According to one aspect of the present disclosure, the periodic or at least essentially periodic (defined here as at least 80% of the volume of the polymer exhibiting a periodic structure) can be prepared with at least two different geometrical configurations, one with a compact nanobubble structure with closed pores (as described as the Embodiment Structure Type A below).

Another aspect of the present disclosure teaches a formation of nanoscale connected pore array structure, or inverse opal nanostructure (as described as the Embodiment Structure Type B below).

### Embodiment Structure Type A: Polymer Nanobubble Structure

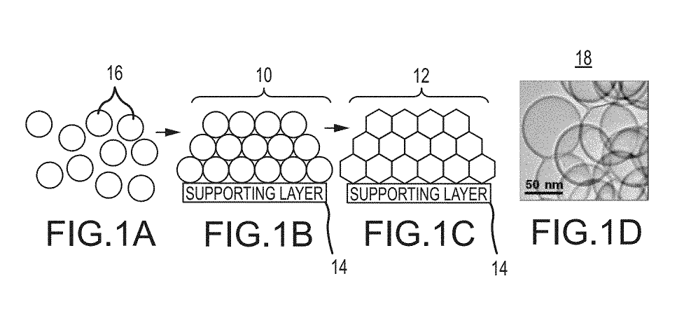

FIGS. 1A through 1D illustrate a method of preparing a polymer foam structure (10, 12) on a supporting layer (14), according to an aspect of the disclosure, in a nanoscale dimension. In order to provide an optically transparent, thermally highly insulating layer useful as glass window insulating material and other uses, the present disclosure provides for the introduction of a nanoscale, sub-divided polymer nanobubble structure which sub-divides air into nanodimensions so as to reduce thermal conductivity. The nanoscale dimensioned structure greatly enhances the mechanical strength as well. Here, hollow polymer spheres (16) of <˜200 nm, preferably less than <100 nm diameter (so as to avoid interference with visible light wavelengths and associated haze problem), are synthesized by spray pyrolysis or sacrificial templating technique.

According to the present disclosure, the synthesis can be carried out by, for example: i) spray pyrolysis (or spray drying) of polymer dissolved solution, or ii) use of a sacrificial solid or hollow sphere shaped polymer (such as polystyrene), metal (such as Ni) or ceramic (such as SiO₂) to be coated with a desired shell material polymer and then the template is dissolved away by acid, base, differentially etching solvent, or using plasma etching, or iii) using micelle type synthesis of hollow polymer nanospheres. The hollow spheres are then compressed and sintered (optionally with a small amount of uncured liquid polymer added, or by adding a small quantity of glue polymer) followed by an additional cure to produce a desired nanoscale foam-like structure (nanobubble structure), which will exhibit a desirably low thermal conductivity, in combination with optical transparency if a proper polymer material is utilized.

The structures detailed in FIG. 1 comprise hollow polymer nanospheres (16) which can utilize various polymer materials including: polystyrene (PS), polymethyl methacrylate (PMMA), polyethylene terephthalate (PET), polybutylene terephthalate (PBT) or polyethylene naphthalate (PEN). Other polymers such as polypropylene (PP), polyester (PES), polyethylene (PR), polytetrafluoroethylene (PTFE), polydimethylsiloxane (PDMS), polyvinylidene fluoride (PVDF), and co-polymers or combinations/mixtures of various polymers, including those mentioned above, can also be utilized.

The desired particle diameter is in the range of 10 nm-5 μm, preferably in the range of 10-500 nm, and even more preferably 10-100 nm. For the specific case of optically transparent insulators suitable for window glass applications, the preferred particle diameter is 100 nm or smaller, preferably 60 nm or smaller, or even more preferably 30 nm or smaller.

The desired wall thickness of the hollow wall nanoparticles is at most about 30% of the diameter, preferably at most about 20%, and even more preferably at most about 10% of the overall average diameter of the hollow particles. For desirably reduced thermal conductivity for insulator applications, smaller, more nanoscale particle sizes of about 10-about 100 nm are used. Such a small particle size is also important for removing the haze type deterioration of optical transparency for window applications, as deep subwavelength dimensions well below the visible wavelength regime of about 400 nm-about 800 nm spectral regions. In order to prevent the haze problem, the dimension of the nanobubble has to be less than about ½, preferably less than about ⅓, and even more preferably ¼ or less of the visible optical wavelength regime of e.g., 400-800 nm. Therefore, the desired pore size in the FIG. 1C type nanobubble polymer structure (12) is at most about 150 nm, preferably at most 100 nm, and even more preferably at most 75 nm.

The desired nanoscale hollow polymer particles (16) can be fabricated by chemical micelle method (also called micro emulsion method), spray pyrolysis technique or by other processing approaches. A TEM micrograph (18) of 70 nm diameter hollow PS nanospheres made by emulsion polymerization, with a relatively mono-disperse size, is shown in FIG. 1D. These hollow nanospheres (16) are stacked in a dense configuration and sintered (or glued), FIG. 1C, to form a nanobubble structure (10, 12) having superior thermal barrier properties and optical transparency. The sintering will be carried out under slightly compressive pressure, for instance by using warm roller compaction for continuous fabrication, near or slightly below the glass transition temperature (Tg) of the polymer involved, or prestacking followed by oven baking (in a continual or continuous manner). The polymers of PS, PMMA are thermoplastic polymers with glass transition temperatures Tg (softening temperature) around ˜107° C. The polymer PET exhibits a Tg of 67° C. for amorphous PET and 81° C. for crystalline PET. Tg of PBT is 66° C. and that of PEN is 125° C. These polymer nanospheres (16) bond to each other when compressed near their Tg. The sintering time will be dependent on the type of polymer, process temperature and time, and applied pressure, which can be determined by experimental procedures. Such a nanobubble polymer structure prepared according to the present disclosure exhibits a desirably low thermal conductivity of 0.02-0.05 W/mK, partly because of the 60-70% porosity (air) in such a designed structure of FIGS. 1A-1D, and partly because of reduced intrinsic thermal conductivity via air subdivision (known as Knudsen effect).

To produce polymer sphere particles (16), the use of proper solvent is an important parameter.

For hollow polymer sphere synthesis needed for polymer nanobubble structures, both thermoplastic and thermosetting polymers (desirably optically transparent for window insulator layer type applications) may be utilized. Thermosetting polymers can more easily produce the hard shells that could provide mechanically more robust structures, while thermoplastic polymers are easier to work with and to sinter. For desired more rapid heating/solidification of the shell surface for ease of more reliable shell formation, higher thermal conductivity gas such as He gas can be used.

For the case of thermoplastic polymers to produce hollow sphere polymer particles by spray pyrolysis type processing, a rapid cooling (after the initial shell formation by solvent evaporation and heating) of the particles will be more beneficial so that the formed shell becomes harder and mechanically durable, while the core solvent liquid or gas can be removed later. As shown in FIG. 1A-1C, hollow polymer nanospheres (16) are stacked into a densely packed layer and sintered to form a nano-bubble structure (10, 12). As shown in FIG. 1D, an example of hollow polystyrene nanospheres (18) (˜70 nm dia, 3 nm wall) is produced.

### Embodiment Structure Type B: Sub-100 nm, Inverse Opal Polymer Nanostructure

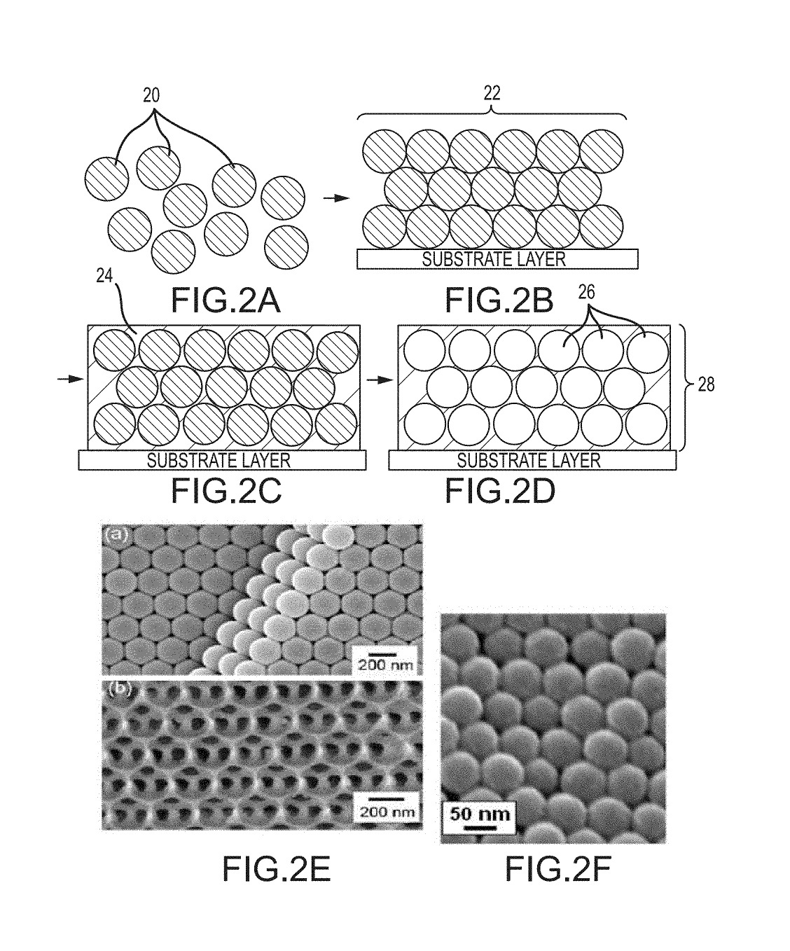

An alternative high porosity configuration of polymer nanobubble structure, according to the present disclosure, consists of nano-hole array within a polymer matrix, as illustrated in FIGS. 2A-2F. Unlike traditional inverse opal structures, which are based on coarser particles (e.g., >200 nm dia) such as silica, a sub-100 nm inverse opal structure, such as needed for super insulator to serve as energy saving insulator for single pane glass window has never been demonstrated. Such a new nanoscale structure based on inverse opal structure with desired thermal insulator characteristics and optical transparency is disclosed in this disclosure, as the nanodimension is the key for achieving both the Knudsen-effect low thermal conductivity and deep-subwavelength induced optical transparency in the particle-porosity assembled structures. Inverse opal structure with a periodic array of nanodimension voids as in FIG. 2 enables optically transparent layer with thermally highly insulating characteristics.

According to the disclosure, an opal structure (20) of ˜60-100 nm diameter, solid PS or PMMA nanospheres is synthesized by spray pyrolysis or chemical micelle synthesis, stacked into a well ordered structure (22) (as demonstrated already in FIG. 2B), followed by capillary injection of another polymer (24) (e.g., UV-curable and optically transparent polyurethane acrylate (PUA) for coarser structures of 600 nm size regime (See: Kim et al., Advanced Materials, (2014)), which is not useful for super insulator purpose and not capable of preventing the haze issue (optical scattering and interference caused by structures having dimensions comparable to visible spectrum wavelength of 400-800 nm) that obscures the clarity of transparent see-through capability for glass windows). In order to prevent the haze problem, the dimension of the nanobubble has to be less than ½, preferably ⅓, even more preferably ¼ or less of the visible optical wavelength regime of e.g., 400-800 nm. Therefore, the desired pore size in the FIG. 2 type inverse opal polymer structure is at most 150 nm, preferably at most 100 nm, even more preferably at most 75 nm.

Once the polyurethane acrylate (PUA) type transparent polymer injection (24) is performed into the “nanoscale” opal structure (22) as described in this disclosure and depicted in FIG. 2C, the PS nanospheres (or silica nanospheres) can selectively be etched away after the PUA injection using a solvent such as toluene to produce an essentially periodically arranged and interconnected nano holes (26) comprising the “nano inverse opal” structure (28) of optically highly transparent PUA, as depicted in FIG. 2D.

Monodisperse, ˜60 nm PS or PMMA hollow nanospheres can be synthesized by easily scalable method of spray pyrolysis as well as chemical micelle approach. Solid monodisperse ˜60 nm nanoparticles of PS or PMMA can be fabricated by both methods for nano inverse opal structuring. Monodisperse polystyrene (PS) colloidal particles are prepared, e.g., by a dispersion polymerization method, using PVP (polyvinylpyrrolidone) plus a solution of ammonium persulfate (APS) initiator for polymerization, with styrene monomer. After the polymerization reaction, the PS particles are washed and collected via centrifugal processing, and periodic stacking is achieved by self-assembly sedimentation and evaporation of ethanol and DI water mixed solvent. For faster formation of opal structure, centrifugal force drying technique can be utilized.

As depicted in FIGS. 2A through 2D, polymer nanospheres (20) of PMMA or PS, ˜60 nm size regime, are produced, densely packed (22) and infiltrated with another polymer (24) such as PUA, followed by selective etch-away of nanospheres to create nanoscale inverse-opal structure with periodic void array (28). In FIG. 2E, inverse opal structure was previously amply demonstrated but with a coarser scale silica nanospheres in Y. Nishijima et al., Optics Exprses, (2007), although a nanodimension inverse opal structure with desirably low thermal conductivity and optical transparency has not been demonstrated so far. In FIG. 2F, the micrograph, according to the present disclosure, clearly shows a near-periodic, high density stacking of ˜60 nm polystyrene nanospheres, which can serve as the basis for formation of nano inverse opal structure.

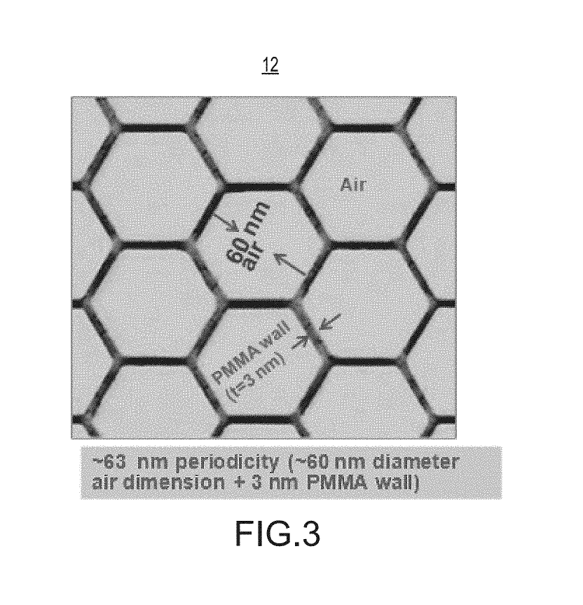

FIG. 3 depicts an example schematic polymer nanobubble structure (12) (cross-sectional diagram) prepared by pressing and sintering of monodisperse hollow polymer spheres. The majority of the heat conduction pathways are polymer walls along the vertical direction. Thermal conductivity of such hollow nanobubble structure is very low to make it suitable as an excellent thermal insulator.

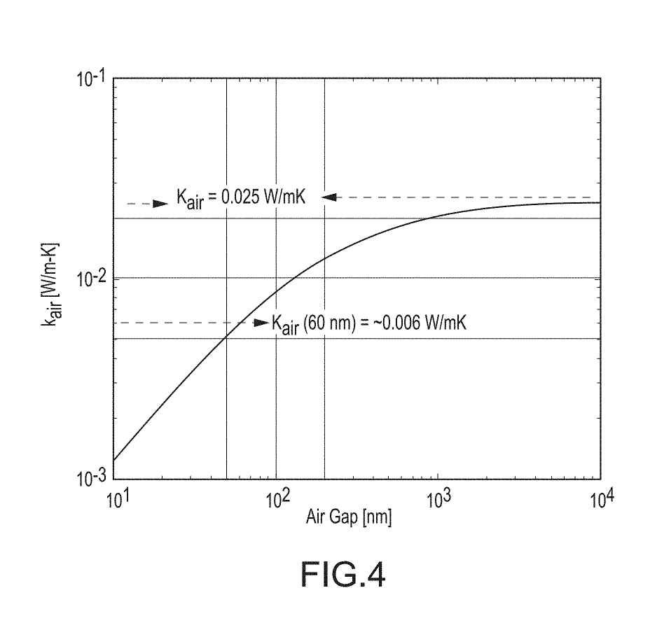

In relation to FIG. 1 type nanobubble structures, shown in FIG. 3 is an example schematic nanobubble structure (12) with ˜60 nm diameter with 3 nm wall thickness to indicate the thermal conduction behavior. The majority of the heat conduction pathways are polymer walls along the vertical direction. The nanobubble structure (12) made of PMMA having the structure in FIG. 1C and FIG. 3, with 60 nm bubble diameter dimension and 3 nm wall thickness contains ˜86% volume of air and ˜14% volume of PMMA (the thermal conductivity K(PMMA) is ˜0.18 W/mK). With a reduced thermal conductivity of air on subdivision to such 60 nm size regime (see FIG. 4), such a structure of FIG. 3 can produce a lowered thermal conductivity of the PMMA nanobubble structure (12) with a value of K ˜0.030 W/mK, and even lower if a vacuum is applied to the nanobubble (as the K of vacuum is essentially zero, or in a vacuum-filled double pane glass window, K value can be less than 0.004 W/m·K). These thermal conductivity values of subdivided polymer structures are much smaller than the bulk polymer thermal conductivity K(PMMA) value (smaller by a factor of 6 even without vacuum), and is comparable to the K(air) value of 0.025 W/mK. Thus the polymer nanobubble structure represents an excellent thermal insulator. Reduction of air thermal conductivity (K) by subdivision of air volume is shown in FIG. 4. When the air volume is made smaller to ˜60 nm size (as in the case of 60 nm diameter hollow sphere), the K value of air is reduced from ˜0.025 W/mK to ˜0.006 W/mK. The polymer nanobubble wall (polystyrene or PMMA material) also contributes to thermal conduction, so the overall thermal conductivity of the hollow nanobubble polymer structure (12) of FIG. 1 is close to ˜0.03 W/mK, about ⅙ of the polymer thermal conductivity of ˜0.18 W/mk. If the particle size is made too be 30 nm, the thermal conductivity of hollow polymer nanobubble structure (12) can be smaller than 0.02 W/mK.

The thermal conductivity values (K) of the hollow or porous structures of FIG. 1 and FIG. 2 are dependent on the pore size as well as the porosity volume % of the structure. For minimal thermal conductivity and maximal optical transparency with reduced haze, the desired hollow sphere size (or pore size containing air) of FIG. 1C type structure is less than 100 nm, preferably less than 60 nm, even more preferably less than 30 nm. If the application of the polymer nanobubble is not for window type uses and hence the optical transparency is not a critical requirement such as in the case of shipping/packing insulators, a larger size hollow polymer spheres can also be utilized, with the desired particle diameter is in the range in the range of 10 nm-5 um, preferably in the range of 10-500 nm, even more preferably 10-100 nm.

FIG. 4 depicts the reduction of air thermal conductivity (K) by subdivision of air volume. When the air volume is made smaller to ˜60 nm size (as in the case of 60 nm diameter hollow sphere), the K value of air is reduced from ˜0.025 W/mK to ˜0.006 W/mK. The polymer nanobubble wall (polystyrene or PMMA material) also contributes to thermal conduction, so the overall thermal conductivity of the hollow nanobubble polymer structure of FIG. 1 is close to ˜0.03 W/mK, about ⅙ of the polymer thermal conductivity of ˜0.18 W/mk.

For the sake of desirably reduced thermal conductivity and enhanced optical light transmission, the degree of porosity in volume fraction in the FIG. 1 and FIG. 2 structures is desirably at least 50%, preferably at least 60%, even more preferably at least 75%.

The thermal conductivity values (K) of FIG. 1 and FIG. 2 type structures, according to the present disclosure, are likely to be extremely low. When the pore size is comparable to the mean free path of air molecules (˜60 nm), the rarified gas effect can reduce the effective thermal conductivity of the air, as shown in FIG. 4. The subdivision of the air space by nanobubble geometry can reduce the thermal conductivity K, with the desirable value of K for the nanobubble polymer structures according to the disclosure being less than 0.10 W/m·K, preferably less than 0.05 W/m·K, even more preferably less than 0.02 W/m·K, especially if a vacuum is introduced to the nanobubble interior. The optical transparency of the nanobubble structures of FIG. 1 or FIG. 2 type layer in the visible spectrum range is desirably higher than 50%, more preferably better than 70%, more preferably better than 80% for window insulator applications. The light scattering by haze phenomenon is less than 30%, preferably less than 10%, even more preferably less than 5%.

In order to obtain low thermal conductivity combined with low haze, the precursor material polymer nanospheres (hollow or solid) with a size regime of 10-100 nm diameter in this disclosure are preferably synthesized so as to exhibit near monodisperse nanoparticle size and agglomeration-free status for the periodic structure of FIG. 1 or FIG. 2 (or near periodic, defined here as ˜80% or higher volume fraction periodic structure). For the case of alternative embodiment of intentionally non-periodic and random particle arrangement structure that will be described later, a monodisperse particle diameter is not desirable. Instead, a non-uniform particle size and a non-spherical particle shape are preferred in that case. For the FIG. 1 or FIG. 2-type structure, the polymer nanobubble structure desirably exhibits a dense stacking of polymer particles with minimal defects so as to minimize the haze problem. In order to ensure these desirable characteristics, the following embodiments and processing approaches are preferred according to the present disclosure.

### Embodiment Structure Type C: Discrete Electro Spray (DES) Approach for Uniform Nanoparticle Synthesis

Nanoparticle synthesis often introduces a quite wide distribution of particle size. For orderly stacking of nanoparticles, it is desirable to minimize particle size distribution. For easier stacking and sintering as well as to achieve higher optical transparency, a minimized defect formation in the sintered nanobubble structure is essential, which can in a sense be ensured with near mono disperse particle size. Such uniform-diameter (mono disperse diameter) hollow polymer particles are important for improved FIG. 1C type structure, while mono disperse solid polymer particles are highly desirable for improved FIG. 2D type structure.

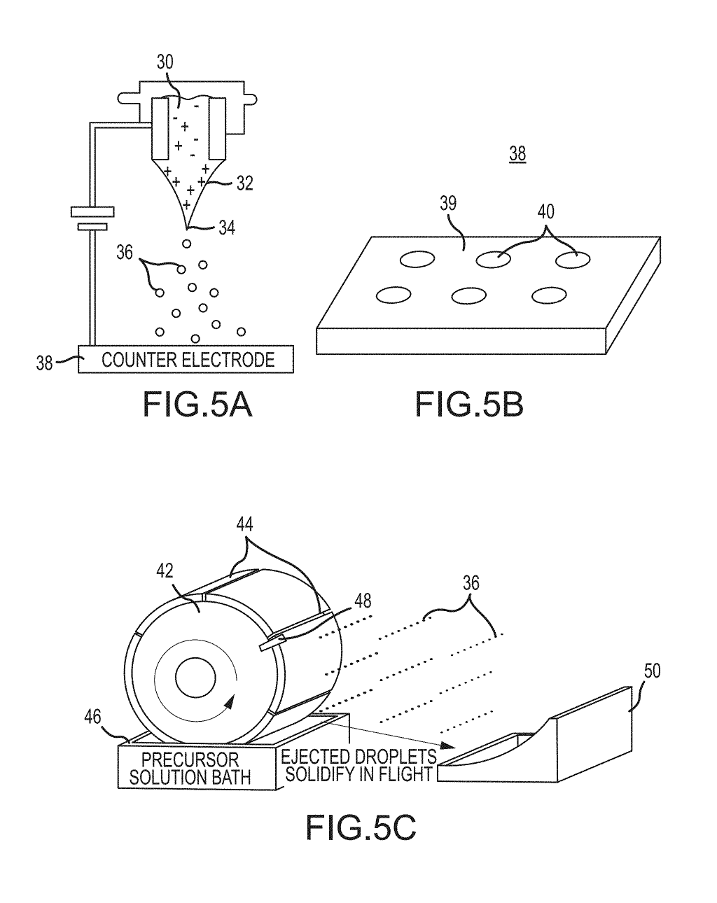

A more uniform particle size can be obtained by utilizing electric field during processing such as a unique utilization of electro-spray of polymer particles, according to the present disclosure. In a typical electro-spray setup as illustrated in FIG. 5A, a conductive fluid under high voltage (30) is drawn into a Taylor cone (32). See: G. Taylor, Proc. R. Soc. Math. Phyx. Eng. Sci. (1964). At the conical apex (34), the charged liquid (30) is ejected as radially dispersed charged droplets (36) which are then captured on the counter-electrode (38). Droplet (36) size is influenced by a variety of factors including liquid conductivity, viscosity, density, surface tension, flow rate and the applied voltage, and may be reduced to nanoscale or even gas-phase ions as employed in some mass spectrometry techniques. See: A. M. Gañan-Calvo et al., J. Aerosol Sci., (1997); A. Jaworek, J. Mater. Sci., (2007); M. Yamasita et al. J. Phys. Chem., (1984).

FIG. 5A depicts a basic electrospray configuration illustrating Taylor cone formation and coulombic fission to emit a jet of liquid drops under high voltage. FIG. 5B depicts an example “Discrete Electro Spray” electrode, in accordance with various embodiments of the present disclosure, with only the patterned island regions (40) made conducive to droplet (36) formation. FIG. 5C depicts an example device schematic of continuous discrete electro spray for high-speed droplet formation. A rapidly rotating drum (42) containing an array of separated hydrophilic islands, or separated patterned substrates (44) is continuously dipped into a precursor solution bath (46) for discrete droplet (36) formation. Coated substrates then contact a stationary high voltage source (48), ejecting individual charged (and hence repelling-each-other) droplets (36). Droplets remain separated in flight and solidify before capture by a grounded collector (50). This new technique is useful for spray pyrolysis or spray drying to form solid particles from precursor solutions containing the chemical components of the eventual particles to be synthesized, e.g., a salt solution or a monomer/polymer precursor solution.

A new technique of producing monodisperse nanoparticles, which is referred to as “Discrete Electro Spray” (DES) here is disclosed. This technique, schematically illustrated in FIGS. 5B and 5C, has been developed to ensure a more precise control of droplet dimension toward near-identical particle size synthesis with a minimal size distribution (e.g., particle diameter variation of less than +/−30%, preferably less than +/−10%). The uniformity of nanoparticle size is important in ensuring a very tight, high density stacking of nanoparticles with minimal defects or voids in the case of periodic stacking of polymeric nanoparticle assembly, so as to minimize the occurrence of haze type light scattering that deteriorates optical transparency. The desirable uniformity of the nanoparticle size, according to the present disclosure, is such that at least 70%, preferably at least 90%, even more preferably at least 95% of the particle size distribution lies within a standard deviation range of −1σ to +1σ. Random, ultrasonic-activated ejection of droplets in typical spray pyrolysis or spray drying tends to produce particles with a very wide distribution of particle diameters and different degree of particle agglomerations, often with less than 70% of the values lie within one standard deviation.

This new technique is useful for spray pyrolysis or spray drying to form solid particles from precursor solutions containing the chemical components of the eventual particles to be synthesized, e.g., a salt solution or a monomer/polymer precursor solution.

An electrode substrate suitable for Discrete Electro Spray can be prepared in at least two different configurations, (a) one type having a periodically distributed hydrophilic islands within hydrophobic matrix, and (b) another type with an array of nanochannels These are described in more detail in the example Embodiment D and Embodiment E below.

### Embodiment Structure Type D: Hydrophilic-Hydrophobic Separation Based Discrete Electro Spray

The first type, illustrated in FIGS. 5B and 5C, is prepared by forming discrete islands (40) conducive to surface droplet formation (e.g., hydrophilic island such as isolated regions/islands coated with a hydrophilic material, e.g., Ti, Zr, Ta, Ni, Co, Fe or their oxides like TiO₂, ZrO₂, Fe₂O₃, surrounded by less favorable areas for droplet formation (39) (e.g., water-nonwettable or solvent-nonwettable hydrophobic surface matrix, such as prepared with (or coated with) Teflon or PDMS (polydimethylsiloxane). Once the dimension of the all the islands (40), the degree of hydrophilicity (or superhydrophilicity), and the speed of rotation are fixed, a particular mono-disperse droplet (36) size is dictated, with associated monodisperse nanospheres obtainable. The desired hydrophilicity in terms of liquid contact angle θc is less than ˜40 degrees, preferably less than 10 degrees. The desired hydrophobicity of the regions surrounding the hydrophilic islands (39) is θc of at least 100 degrees, preferably at least 140 degrees. The desired liquid droplet (36) size depends on the desired nanoparticle size. While the solid nanoparticle size depends on the volume concentration of the dissolved precursor material in the liquid droplet, a crude rule of thumb is that the eventual solid particle size is on the order of ˜5-20 times smaller than the size of the liquid droplet precursor solution. Therefore, in order to achieve sub-100 nm size solid nanospheres or hollow nanospheres, the droplet diameter has to be 0.5-2 μm or smaller, which dictates that the hydrophilic island (40) size should be in the level comparable to these droplet (36) diameters. (It should be noted that if the precursor solution is based on non-aqueous, oil-based material such as hexane, benzene, xylene, the islands and the surrounding matrix in the Discrete Electro Spray need to be reversed, i.e., the islands have to be hydrophobic and the matrix has to be hydrophilic. Such a reverse case is also a part of this disclosure. An example is a polymethyl methacrylate (PMMA) or polystyrene (PS) polymer or monomer dissolved in a non-aqueous solvent such as toluene, benzene, xylene or acetone.)

In the case of hydrophilic precursor solutions, the diameter of nanoparticles is pre-dictated by the hydrophilic island (40) size, precursor solution contact angle onto the patterned islands, and the speed of drum rotation during the continuous fabrication of identical-diameter polymer nanospheres.

During the Discrete Electro Spray process using the FIG. 5A or FIG. 5C type device, dipping, spinning, or some other coating method is utilized to form discrete droplets only on the hydrophilic island regions favorable to wetting. These arrayed droplets (36), which may contain precursors (such as salt solutions or polymer-dissolved solvent solutions) for nanoparticle production, are then ejected from the electrode by application of sufficient voltage at the counter electrode (38). The solvent (or water) in aerosol evaporates in travel to produce micro- or nanoparticles before capture at the counter-electrode. Particle characteristics are dependent upon component concentrations of the liquid as well as the surface droplets geometry, particularly contact angle and diameter. For a targeted ejected droplet diameter, it is possible to select an appropriate pattern diameter (contact angle dependent) on which a liquid will persist on the surface long enough for the Discrete Electro Spray process.

### Embodiment Structure Type E: Nanochannel Based Discrete Electro Spray Embodiment

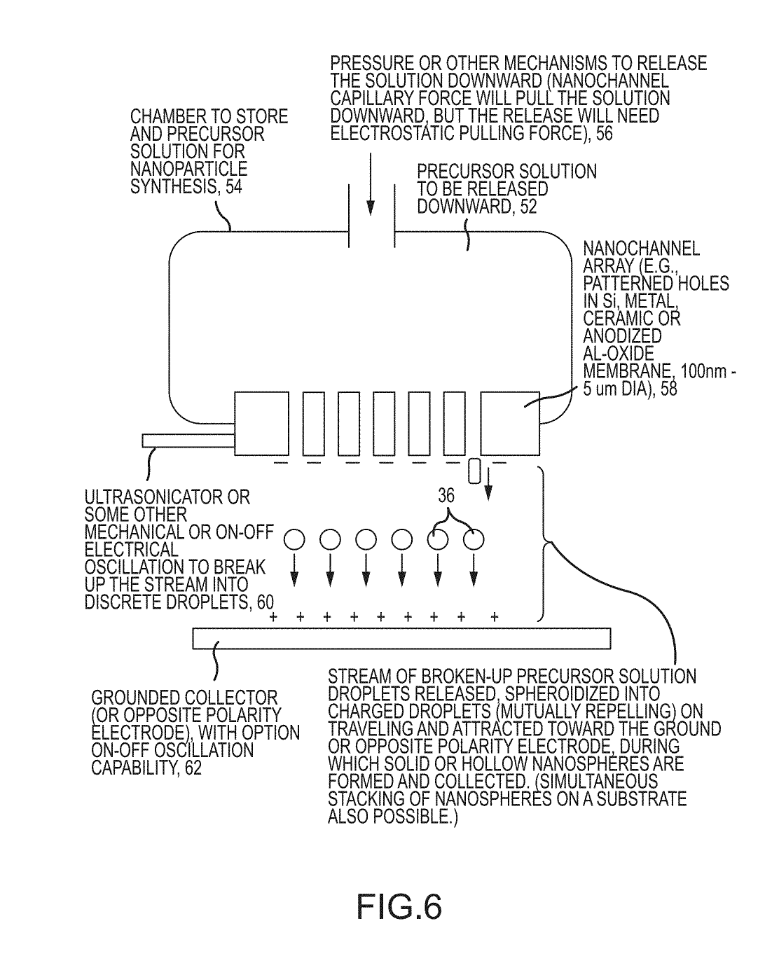

The second type of device for Discrete Electro Spray contains an array of nanochannels such as illustrated in FIG. 6. Here the precursor solution (52) containing polymer (or ceramic material) dissolved within is stored in a chamber (54), and then is pushed downward by using an applied pressure (56) or other mechanisms to as to release the solution through the nanochannels (58) with a pre-defined diameter. For smaller nanochannels, the capillary force will pull the solution (52) downward, but the release of the solution off the nanochannel can be made easier by electrostatic pulling force via applied electric field, e.g., 10,000-20,000 volts. The nanochannel array (58) can be made by using standard lithography or nanoimprinting lithography to produce periodically patterned vertical holes in Si, SiO2, metal, or ceramic material. Reactive ion etching (ME), chemical etching (e.g., using catalytic etching using Au, Ag, Pt, Pd) or electrochemical etching can be used for the formation of vertical hole array. A self-assembly method such as anodized aluminum-oxide (AAO) membrane can also be used to prepare the vertical hole array.

The dimension of the vertical holes are in the range of, e.g., 50 nm to 20 μm diameter, preferably in the range of 200 nm-5 μm diameter. The height of the nanochannel layer can be in the range of e.g., 1-5,000 μm, preferably 10 μm to 2,000 μm, even more preferably in the range of 50 μm to 1,000 μm. As the membrane has to endure the applied pressure, a thicker layer is preferred. A thinner layer can be utilized if some protective coarser mesh grid is provided for mechanical reinforcement.

Pressure-induced, downward ejection of the precursor solution tends to be in the form of a continuous stream. In order to break up the stream into discrete droplets, an ultrasonicator (60) or some other mechanical or on-off electrical oscillation can be utilized, according to the present disclosure. An electric field applied to extract the droplets (36) from the membrane holes tends to make the droplets (36) electrostatically charged so that the neighboring droplets (36) repel each other to minimize undesirable coalescence of droplets.

Once broken-up precursor solution droplets (36) are released, they will be spheroidized during their free fall because of the surface energy minimization driving force present. The electric field can be on-off operated to minimize any elongation of the droplet. The droplet spheres with pre-defined diameter (as dictated by the nanochannel diameter and on-off frequency of the applied electric field) will be attracted toward the ground or opposite polarity electrode (62) below, during which time solid or hollow nanospheres are formed, and collected on a substrate. Such monodisperse nanosphere formation process can optionally be combined with an electrostatic-field-induced stacking of nanospheres on a substrate by self-assembly type process, which is more convenient.

This important concept of “Discrete Electro Spray (DES)” presented here in FIG. 5 to FIG. 6 will allow to accomplish, in a predictable way, an important and necessary condition for minimal haze-scattering periodic structure, i.e., to produce uniform-diameter, separated nano droplets of precursor solution (of PMMA or PS polymer dissolved in solvent), and hence uniform-diameter (monodisperse) nanospheres of polymers desirable for dense, essentially defect-free stacking. Simultaneous stacking of nanospheres on a substrate is also possible.

### Embodiment Structure Type F: Nanoparticle Stacking for Layer Formation to Fabricate Polymer Nano-Bubble Structures

The polymer nanobubble or nano compartment structures provide excellent thermal insulation properties due to the significantly reduced thermal conductivity. For some thermal insulation applications, optical transparency or reduced haze characteristics are not needed. However, for some applications such as thermal insulation on single pane glass windows for buildings and homes, and also space craft or airplane windows, optical transparency is important and hence minimizing haze is essential. To reduce undesirable haze, it is important to minimize stacking defects in a stacked nanosphere or nanopore array layer structure. Such defects or aggregates of defects often lead to a size dimension of more than 200 nm, which is sufficiently close to the visible light wavelength regime to cause scattering and diffraction of visible light to induce undesirable haze effect. In order to minimize the average degree of haze, the embodiment in this disclosure desirably has a defect density of below ˜20% in the stacking, preferably less than 5%.

In order to reduce the stacking defects toward minimal haze, the following structural and processing approaches are utilized in this disclosure. Polymer nanoparticle diameter (or hollow nanosphere diameter) has to be very uniform, preferably monodisperse, with a particle size distribution is tight having at least 80%, preferably more than 90%, even more preferably more than 95% of the particles have diameter within 10% variation from the mean value of the diameter.

To obtain such a uniform nanosphere diameter, the present disclosure uses:

(a) A unique particle synthesis technique, called “Discrete Electro Spray” (DES) technique of FIGS. 5A-5C and FIG. 6 can be utilized so that the diameter of nanoparticles is pre-dictated by the hydrophilic island size, precursor solution contact angle onto the patterned islands, and the speed of drum rotation during the continuous fabrication of identical-diameter polymer nanospheres.

(b) The nanoparticles or nanospheres have to be individually separated during flight/movement toward the substrate, avoiding any pre-agglomerated particles (including twins or three-some particles), the presence of which will cause stacking defects on packing the nanoparticles into a densely packed layer structure. To enable this, a surface electrical charge will be added to repel adjacent nanoparticles during processing, so that the agglomeration of particles is substantially minimized. The Discrete Electro Spray (DES) technique, by virtue of applied electric field, may assist in the formation of the surface charge, but an additional method of utilizing enhanced surface charge on precursor polymer solution droplets such as SDS (sodium dodecyl sulfate) type anionic surfactant will be helpful.

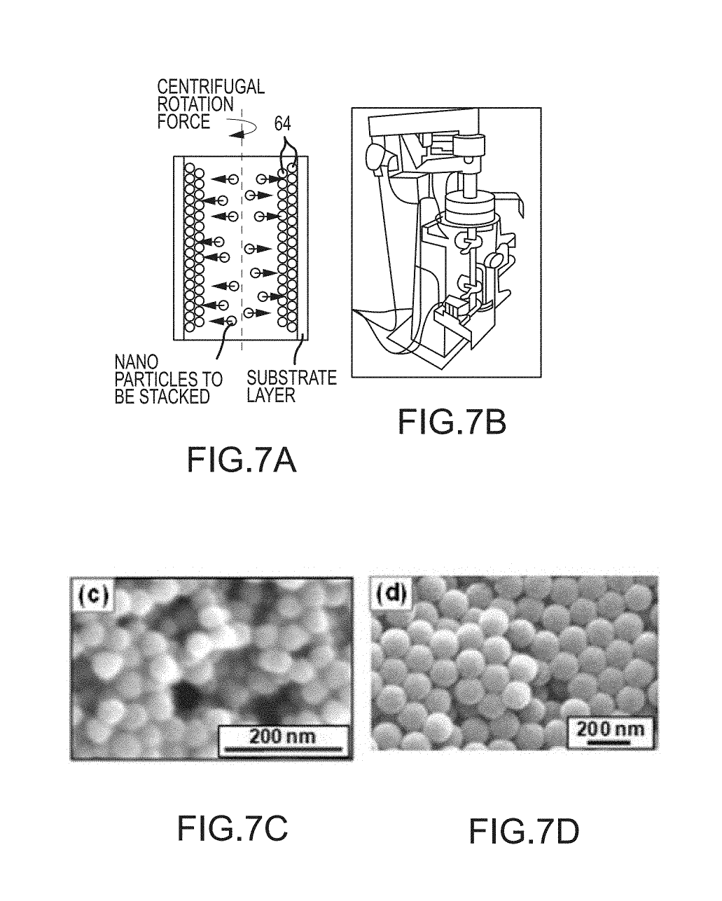

Referring now to FIGS. 7A-7D, FIG. 7A depicts example schematics of centrifugal packing/drying for higher density nanoparticles (64). FIG. 7B depicts an example of a centrifuge dry machine. FIG. 7C depicts an SEM micrograph of silica NPs dried without centrifugal force showing many stacking defects. FIG. 7D depicts an example SEM of polystyrene NPs (with sodium dodecyl sulfate (SDS) anionic surfactant) dried at 4,000 rpm centrifugal force exhibiting high-density packing with minimal stacking defects.

(c) Nanoparticle Stacking into Layers: Millimeter level thick layers (e.g., 1-3 mm thickness) can be produced in sequence, one layer by layer (implying slow speed of particle stacking), with minimal inter-particle sticking during flight or movement of the nanoparticles, e.g., caused by van der Waals force or electrostatic attraction or other mechanisms. Suitable driving force should be provided to enable such orderly stacking. However, the speed of such stacking has to be reasonably fast for scale-up manufacturing for commercial applications. Therefore, one or more of the following innovative yet inexpensive and scalable/manufacturable particle stacking process techniques are developed and described in this disclosure. Such high-density packing to form a usable layer configuration is to be done while minimizing the nanoparticle stacking defects which, if sized larger than ˜½ of the visible spectrum dimension, can cause undesirable haze and some loss of optical transparency.

i) Centrifugal Drying Stacking method (see FIGS. 7A-7D),

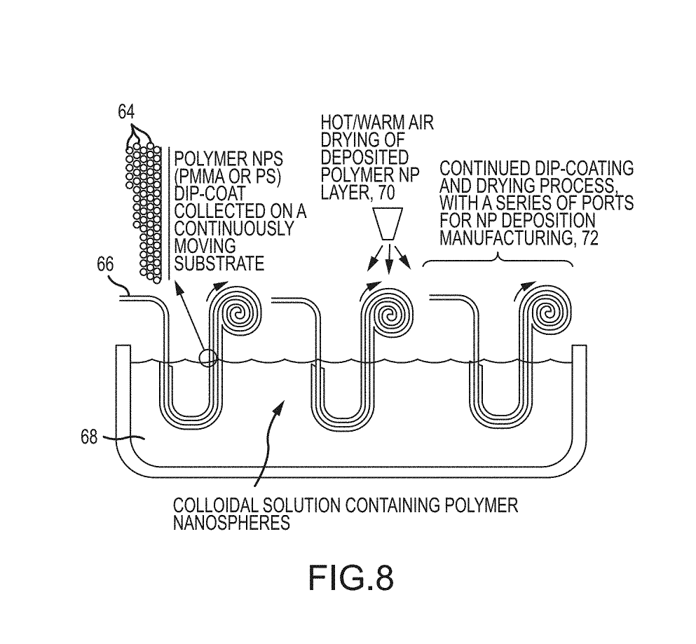

ii) Continuous Dip Coating Stacking method (see FIG. 8),

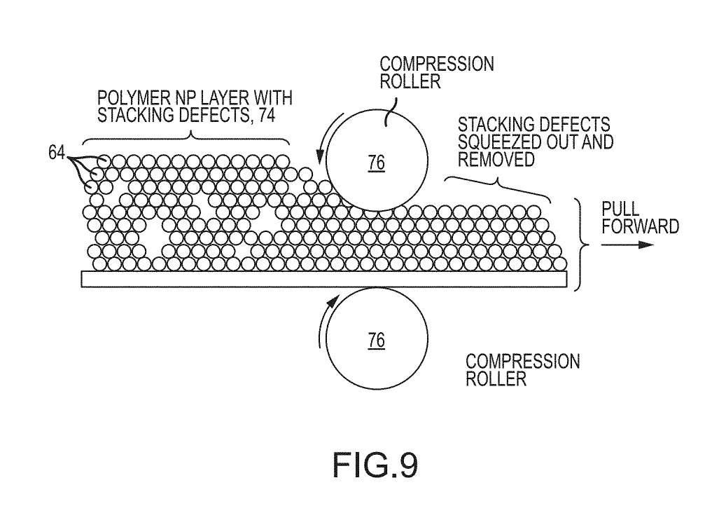

iii) Roller Compacting Stacking method: If there are more stacking defects than desired, the unwanted large voids can be squeezed out by nanoparticle redistribution for improved stacking order. To this end, we will utilize a Roller Compacting technique to enhance the packing of hollow or solid nanospheres (FIG. 9). It is noteworthy that this defect-reducing step can also be utilized to simultaneously perform the sintering/fusion of hollow nanospheres into hexagonal lattice dense structure by using warm rolling (e.g., inside a conveyer oven set near the Tg, e.g., 100-150° C.). for easier and faster manufacturing, instead of cold rolling followed by an extra sintering step.

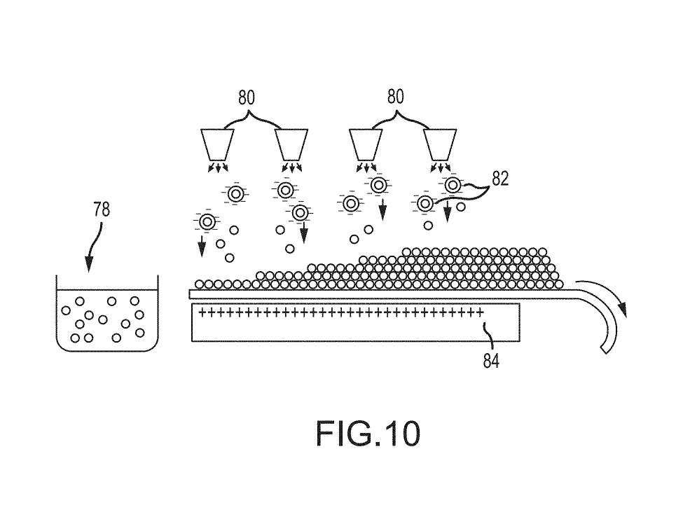

iv) A new, continuous “Electro-Stacking” technique that uses electrical-field-actuated stacking of nano particles, described in FIG. 10, which utilizes applied electric field for enhanced sphere stacking.

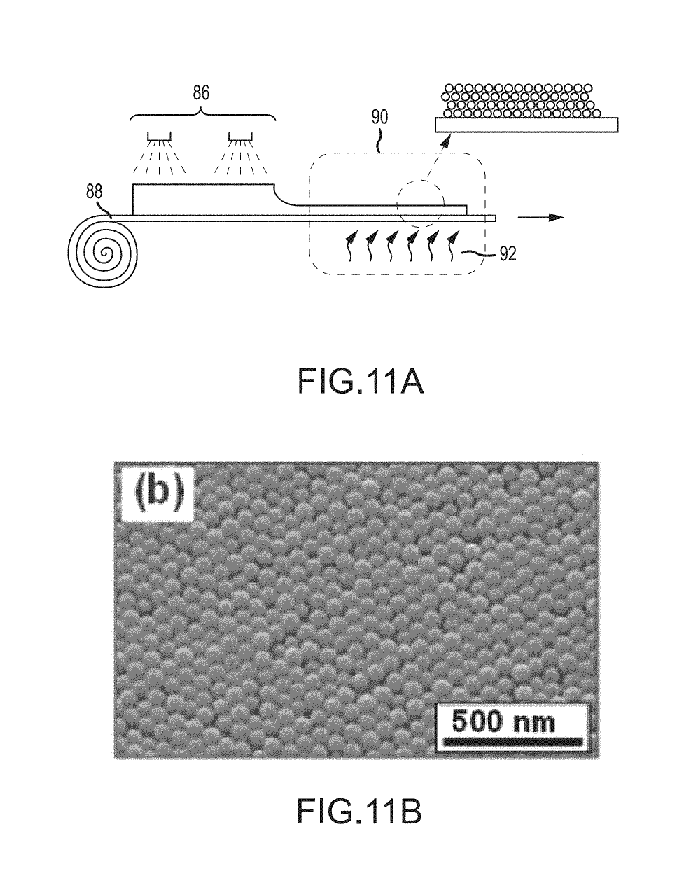

v) A surfactant-assisted evaporation for self-assembly dense stacking (see FIGS. 11A and 11B).

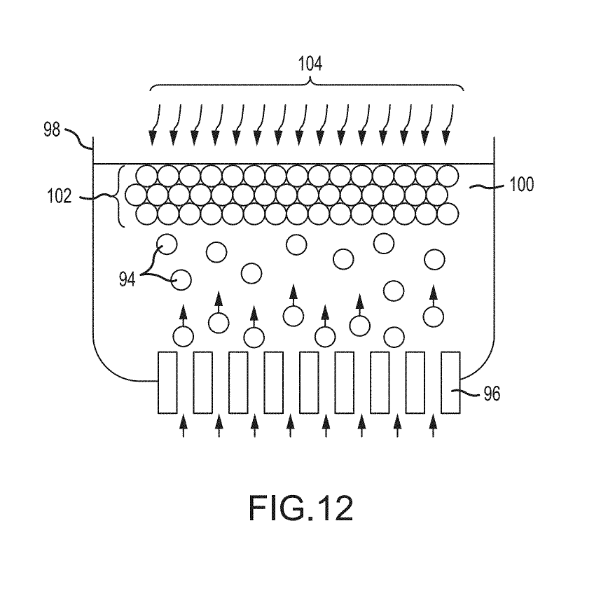

vi) Air bubble stacking technique (see FIG. 12).

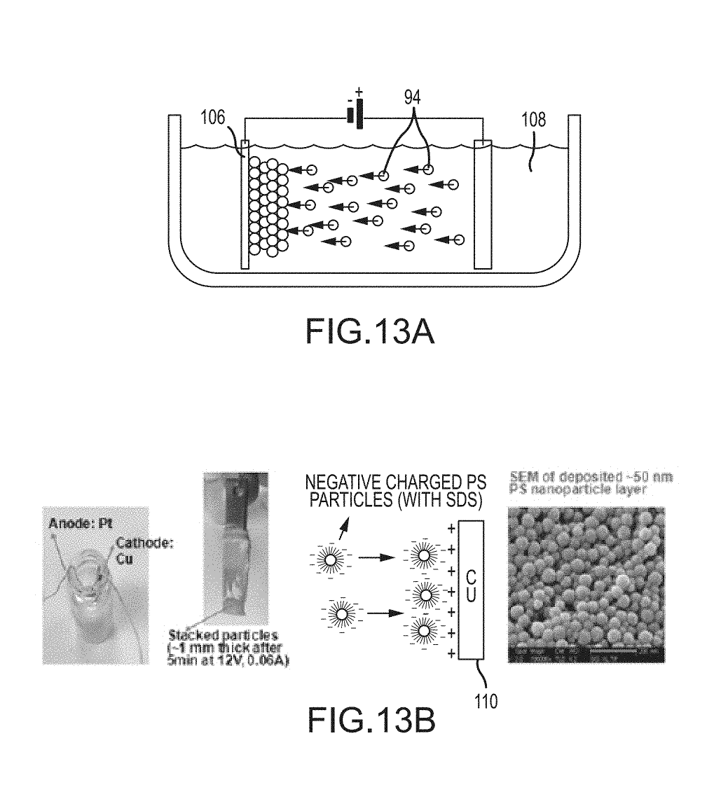

vii) Electrolytic or electrophoretic movement of polymer nanoparticles for stacking into a densely packed layer (see FIG. 13).

Described in FIGS. 7A-7D is a centrifugal packing and drying method that can be utilized for the proposed work for dense stacking of nanoparticles with minimal defects. In this example, the polystyrene (PS) nanoparticles (64) (˜130 nm dia) are well packed with minimal stacking defects, FIG. 7D, as compared to the silica NPs dried without using the centrifugal force, FIG. 7C. The centrifugal packing-drying technique is amenable to high speed, scalable assembly of nanoparticles for commercial scale manufacturing. A larger diameter and higher-speed centrifugal dryers (e.g., www.gala-industries.com) having a capacity of 100 tons/hr will increase the yield for nanoparticle stacking for either hollow-nanosphere sintering technique (FIG. 5) or inverse-opal structuring (FIG. 6) for nano-bubble layer synthesis and commercial manufacturing. Continuous electro stacking FIG. 10 and continuous surfactant-assisted evaporation FIG. 11 illustrate desirably continuous, scaled-up stacking techniques that can be further developed into viable industrial processes for large-scale thermal barrier layer production.

FIG. 8. depicts an example of a method of continuous and sequential dip coating of polymer nanospheres into dense stacking, where dip-coated polymer nanoparticles (64) (PMMA or PS) are collected on a continuously moving substrate (66) from a colloidal solution containing polymer nanospheres (68). Hot/warm air drying (70) of the deposited polymer nanoparticle layer occurs, and the dip-coating and drying process is continued (72) with a series of ports for nanoparticle deposition manufacturing.

FIG. 9 depicts a roller compacting technique for densifying stacked polymer nanospheres (64) (hollow or solid), optionally with simultaneous sintering accomplished. In the Roller Compacting technique, a polymer nanoparticle layer with stacking defects (74) is pulled forward through compression rollers (76) that squeeze out and remove stacking defects.

Presented in FIG. 10 is the new “Electro-Stacking” technique in a continuous process mode that uses electrical-field-actuated stacking of nano particles, as mentioned before. The application of an electric field is one more parameter added to enhance the manipulation of nanosphere stacking. This technique allows for electrical-field-actuated, densely packed stacking of hollow (or dense) nanospheres with minimal defects. Some surfactant may also be utilized. In a first step (78), the premade PS or PMMS nanospheres are wetted in an electrolyte to provide surface charge (e.g., by adding anionic SDS or cationic CTAB surfactant). In a second step, a stationary array of sprayer nozzles (80) (e.g. 100 nozzles) releases charged, mutually-repelling PS or PMMA nanospheres (82) for electro-stacking onto a substrate or carrier sheet (84), which is continuously pulled forward and wound into a spool. After spraying, there is a dry/cure step where the stacked nanospheres are dried and/or cured. This may be done by oven, IR heat lamp, broad laser beam, or any other method known in the art for drying and/or curing.

Shown in FIG. 11A is a schematic illustration of continuously operating surfactant-assisted evaporation technique for high-density, ordered stacking of 60 nm polystyrene nanospheres. The polystyrene (PS) nanospheres were fabricated by micelle type processing in this case, but they can also be fabricated in larger-quantity using more scalable, spray pyrolysis technique. An example SEM micrograph of such aligned and stacked PS nanospheres is depicted in FIG. 11B. An example laboratory micelle process is as follows; Sodium dodecyl sulfate (SDS) anionic surfactant 2.5 g in 20 ml water and 2.3 mL MeOH were well mixed/stirred for 1 hr. 4.2 mL iso-octane was then mixed for 2 hrs, and then 2 mL styrene and 1 mL hexanediol dicrylate were mixed for 2 hrs. Finally ammonium persulfate (APS) 0.04 g was mixed and reacted at 70° C./3 hrs, followed by washing with MeOH. The nanosphere-containing solution was then dried into 1 mm thick ribbon as a near-periodic, three-dimensionally well stacked nanosphere array structure by using temperature gradient evaporation method at 80° C.

According to the present disclosure, a continuous and inexpensive process of stacking approach illustrated in FIG. 11A is desirable for scalable processing for large-area sheets (e.g., >1 m² area). A multi-nozzle spray coat of ˜60 nm nanospheres (PS or PMMA) in colloidal solution with a surfactant (86) is coated onto a substrate (88) which is pulled continuously forward into an oven (90) with a heating coil array (92) which heats the nanosphere stacked substrate. The heat may be infrared heat, a hot metal block, or hot air blowing. As the time required for 1 mm thick layer stacking was only 2 minutes, the FIG. 11A type facility can be set up in such a way that all the PS material layer will be exposed to a gradient temperature (e.g., 80 degrees at the bottom and lower temperature at the top) for ˜6 minutes to produce 3 mm thick stacked PS nanosphere layer. If hollow nanospheres are stacked, the layer can directly be converted into nano-bubble structure by roller compaction sintering in a continuously processable oven (FIG. 9). If solid PS polymer nanospheres are used, inverse opal processing with polyurethane acrylate (PUA) injection and selective etching away of PS will create a periodic, ˜60 nm diameter nano-void array, suitable for formation of transparent and highly insulating thermal barrier layer.

The use of surfactant is important as the surface charge prevents agglomeration of nanospheres. For orderly three-dimensional packing, a temperature gradient evaporation was found to be convenient. It is likely that the use of surfactant provides a repelling force between neighboring nanospheres to assist in the sequential stacking and to minimize agglomeration and out-of-order stacking. A cationic surfactant such as CTAB (cetyl-trimethyl ammonium bromide) may also be utilized instead of anionic SDS (sodium dodecyl sulfate) surfactant.

### Embodiment Structure Type G: Air Bubble Stacking Technique

An alternative embodiment to create a polymer (or ceramic) material having a monodisperse porosity, in analogy to FIG. 6 inverse opal like structure, is to utilize air or gas bubble stacking, according to the present disclosure. This embodiment is schematically illustrated in FIG. 12. Monodisperse air or gas bubbles (94) with essentially identical diameter are created by using nanochannels in combination with ultrasonication, and are sent upward to the chamber (98) containing a somewhat viscous polymer precursor solution (100). This may be accomplished through use of a nanostructured surface or nanochannel array (96), using an ultrasonicator or other mechanical or on-of electrical oscillation that can break up the air (or gas) into bubbles (94). The stacked air or gas bubbles (94) accumulate to a near periodic structure (102) within the viscous polymer solution (100). Some mechanical vibration may be optionally utilized for enhanced self-assembly. The nanochannel structured material should have a preferentially vertically aligned nanopores (such as in self-assembled anodized aluminum oxide (AAO) pores, or intentionally nanopatterned membrane using photolithography, e-beam lithography, nanoimprinting technique or other means), with its desirable pore diameter in the range of e.g., 10-500 nm, preferably in the range of 20-200 nm.

The air bubbles (94) are then accumulated near the top surface of the polymer solution (100). The polymer regions with self-assembly-stacked air bubbles are then cured by surface heating (104) with IR, microwave, or other heating, or UV light exposure causing UV polymerization, and retrieved for use as a nanoporous insulator material. The pore size (the air bubble size in the cured polymer) is dictated by the diameter of the nanobubbles, which is in turn dictated by the diameter of the nanochannel and the frequency of ultrasonic vibration. The desired pore size (air bubble size) in the polymer is in the range of 10-2,000 nm, preferably 20-200 nm, more preferably in the range of 30-100 nm.

Shown in FIG. 13 is an example electrolytic (or electrophoretic) deposition of polystyrene nanoparticles (94). FIG. 13A represents a schematic illustration of electrolytic stacking of charged polymer nanoparticles (94) (e.g., coated with ionic surfactant) into a thick insulator layer (106) in a liquid bath (108) such as in water. An experimental demonstration of the electrolytic stacking of polystyrene (PS) nanoparticles (˜60 nm size) on Cu cathode (110) is described in FIG. 13B. For convenient release of the deposited polymer nanoparticle layer, the cathode (110) can be a removable conductor material such as thin Cu or Ni foil, either stationary or continually (or continuously) moving. After the nanoparticle deposition, such a metallic foil substrate can be easily etched away by dilute acid, or can be mechanically peeled off. Alternatively, a release paper such as a porous teflon or metallized dielectric membrane can be utilized to allow electrical operation during the particle deposition but to be eventually separated from the stacked polymer particle layer (either before or after particle-particle bonding operation step) so that the insulator layer can be retrieved, transferred and bonded onto a carrier sheet. The stacked polymer layer has van der Waals bonding among the neighboring nanoparticles, but can be strengthened further, if desired, by additional particle-particle bonding using sinter-bonding by heating to near TG temperature and applying some pressure, adhesive bonding, or the layer can be encased in a protective membrane bag.

### Embodiment Structure Type H: Phase Separation Induced Nanoporous Polymer Embodiment

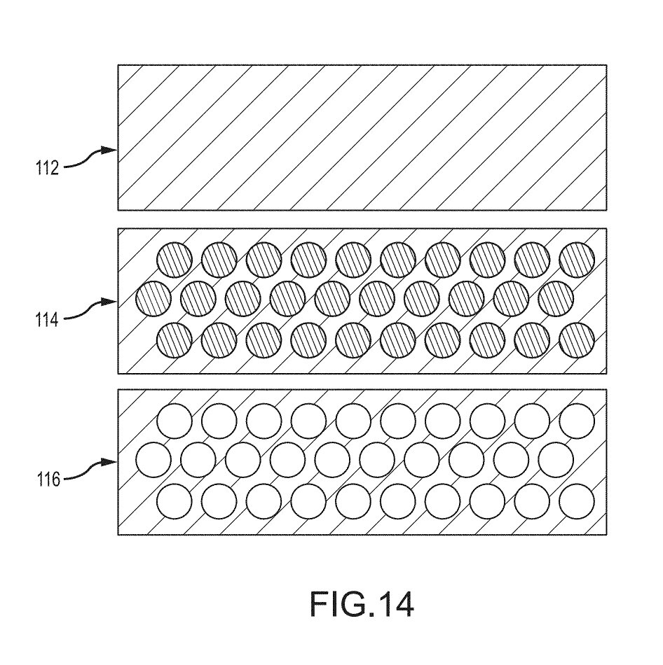

Nanoporous polymer structure suitable for superior insulator applications can also be prepared by phase separation, according to the present disclosure, as illustrated in FIG. 14. For example, diblock co-polymer or triblock co-polymer (112) may be subjected to an annealing treatment to induce a phase separation, sometimes with a very fine features as small as 10˜20 nm size. PMMA and PS polymer blends (PMMA-b-PS diblock co-polymer) can be made, e.g., by using 50/50 PS/PMMA films spun cast from toluene solution onto silicon substrates. These samples are then annealed in vacuum at 100-180° C. to induce the phase separation. Phase decomposition into nanostructures (114) (e.g., to PMMA+PS) preferably results in a periodic array structures with very small feature sizes of, e.g., less than 60 nm, more preferably less than 30 nm. By chemically dissolving away one of the phases (or by plasma etching), the other phase is now a periodically nano-porous polymer layer (116) (e.g., PS or PMMA) with air porosity and enhanced thermal insulation. This can be repeated for thin layers, which can be stacked up to form a bulk material.

### Embodiment Structure Type I: Modified Spray Pyrolysis Approach for Hollow Nanosphere Synthesis

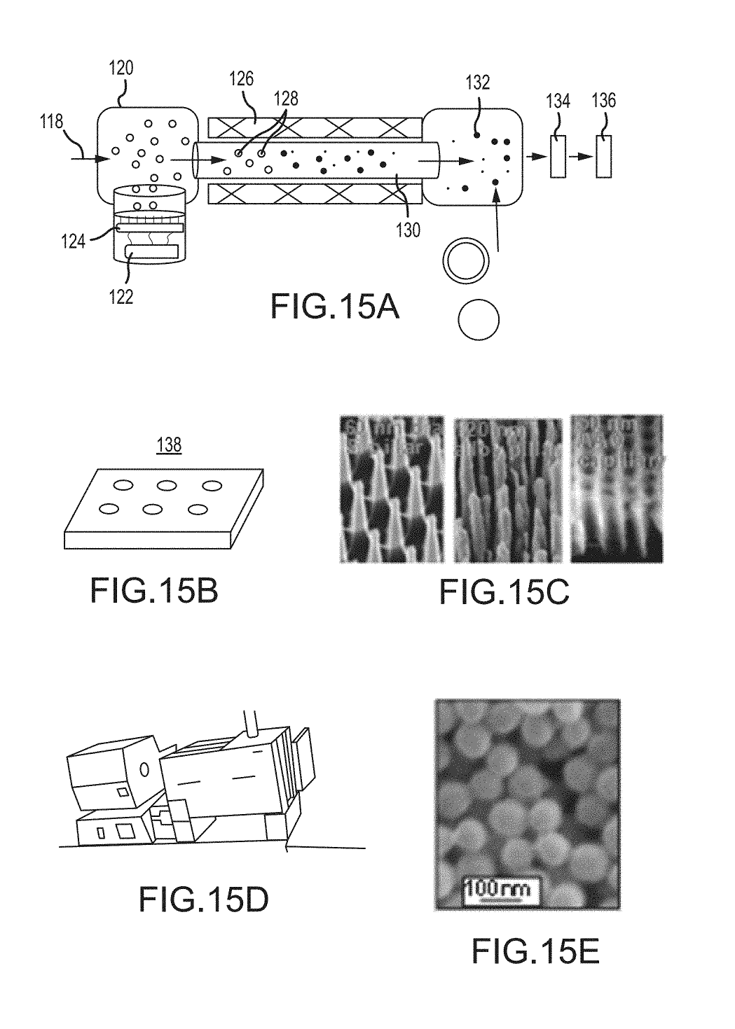

The mechanism of creating hollow polymer nanospheres from a precursor droplets (e.g., of PMMA or PS precursor solution in solvent and/or water) during “spray pyrolysis” (which may also be called “spray drying”) involves a preferential reaction on the droplet outer surface and formation of polymer shell first, which is then followed by diffusional addition of polymer molecules onto the interior surface of the shell material, as depicted in FIG. 15A. A carrier gas (118) (e.g., nitrogen, argon, etc.) is pushed through a chamber (120) with a nebulizer (122) (piezo-electric transducer) and a DES or nano-mist generator (124) (see FIG. 15C) containing polymer and solvent (and optionally water) mixed into a precursor solution, and then into a tube furnace (126) where the solvent-containing droplets (128) enter a quartz tube chamber (130) and undergo rapid shell formation. Then, the hollow polymer spheres and the solvent (and optionally water) molecules (132) exit the chamber into a solvent or water trap (134), and then into an electro-static collector (136). The spray pyrolysis method according to the present disclosure offers a unique capability of shell creation as the nano-droplets are rapidly injected into and exposed to the hotter environment so as to essentially instantaneously induce surface drying for shell formation. This shell formation step is immediately followed by the particle moving to the lower temperature region for slower reaction/deposition of the left-over polymer component material onto the inside surface of the hollow shell. The precursor solution will then eventually be almost depleted of the polymer component with mostly the solvent component left over, which can be evaporated or drained especially if the polymer shell has some porosity. A precise control of processing techniques (discrete droplet size control, droplet movement time vs temperature sequence, together with the optimization of initial concentration of polymer dissolved in a solvent), will lead to reproducible production of hollow nanospheres.

The spray pyrolysis can be performed at 60-150° C. depending on the choice of polymer (or monomer) and solvent materials, and preferentially in combination with the patterned Discrete Electro Sprayer (DES) sprayer with the hydrophilic island array (138) in the hydrophilic matrix (or vice versa if the spray solution is organic hydrophobic type) (see FIGS. 15B and 15D). For insulator applications with optical transparency, it is desirable to have the polymer nanoparticles having an average particle size of 10-100 nm, preferably mono-disperse, hollow nanospheres for FIG. 1 type processing. Hollow polymer nanospheres have been fabricated by spray pyrolysis (see FIG. 15E). The spray pyrolysis can be a high-speed, high-yield process, suitable for mass production, with the yield significantly higher than that in typical chemical synthesis. The particles so generated can be stacked into highly compacted, low-defect-density layers (1-3 mm thick) using one or more of the novel techniques including centrifugal dry stacking, electro-stacking, continuous dip coating, surfactant-enhanced evaporation drying, roller compacting, air bubble stacking, or electrolytic deposition stacking methods described earlier (FIG. 7-FIG. 13) described earlier.

### Embodiment Structure Type J: Non-Uniform-Diameter, Non-Periodic, AMORPHOUS ARRAY Structured Polymer Nanoparticle Assembly with Intentional Nano-Defects for Enhanced Porosity, Improved Thermal Insulation and Reduced Optical Haze Problem

There are many types of polymer materials that can be fabricated into nanoparticles and assembled into novel nanostructures for enhanced thermal insulation. Some of the polymers suitable for this embodiment can be selected, according to the present disclosure, from the list of materials including (but not restricted to) polymethylmethacrylate (PMMA), polyethylene terephthalate (PET), polystyrene (PS), polypropylene (PP), polyester (PES), polyethylene (PE), polytetrafluoroethylene (PTFE), polydimethylsiloxane (PDMS), polyvinylidene fluoride (PVDF), polyethylene naphthalate (PEN), Polybutylene terephthalate (PBT), and co-polymer thereof and any combinations thereof.

The fabrication of nanoparticle polymer materials can be accomplished by various means. One technique using emulsion method utilizes monomers or precursors of polymers, together with one or more surfactants (ionic or non-ionic, 10-60 volume %), solvents and cross-linkers.

The polymerization can be accomplished either by thermal polymerization or by photo-induced polymerization. Some typical hydrophobic solvents utilized for emulsion synthesis of polymer nanoparticles have the chemical structure of a benzyl group and its molecular weight does not exceed 300 such as benzene, toluene, xylene, trimethylbenzene, ethylbenzene, diethylbenzene, butylbenzene, indane and etc. The hydrophobic solvent could be 10%-800% per monomer volume. The amount of cross-linker is 5%-30% per monomer volume. Example cross-linkers can be divinylbenzene or alkylmethacryalte.

For insulators based on polymer nanostructures, an optical haze problem of unwanted light scattering is one of the major challenges to resolve as optical transparency is required/desired for many glass window applications. One of the main causes for the haze problem is the presence of defects, the dimension of which is getting close to the visible spectrum range of e.g., λ˜400 nm to ˜800 μm wavelength regime. When the size of defects (e.g., voids, line defects, microcracks and so forth) in the nanoparticle array structure is reduced to less than ½, preferably ⅓, even more preferably ¼ or less of the visible optical wavelength regime of e.g., 400-800 nm, the haze problem is substantially reduced due to the deep optical sub-wavelength defects of e.g., sub-100 nm size. Therefore, the desired defect size in the polymer structure is at most 150 nm, preferably at most 100 nm, even more preferably at most 75 nm.

As long as the dimension of the defects can be controlled to the deep optical sub-wavelength of λ˜10-100 nm regime, with minimal number of larger defects of e.g., 200 nm or larger, the nanostructure, e.g., a polymer nanoparticle stack structure does not have to be periodic lattice structures, which makes the large-scale manufacturing much easier and less demanding. A “NON-PERIODIC ARRAY” or “AMORPHOUS ARRAY” structure of nanoparticle stack can be more advantageous since such a non-periodic array yields a desirably higher porosity than close packed, periodic array structure (and resultant lower thermal conductivity).

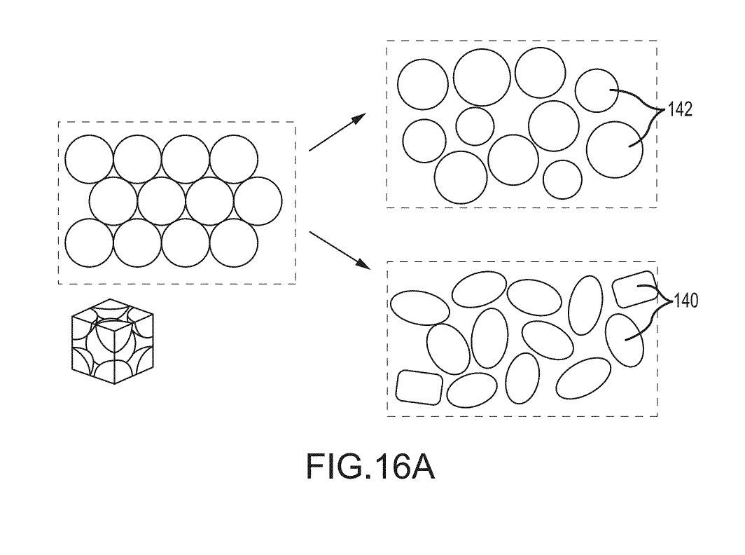

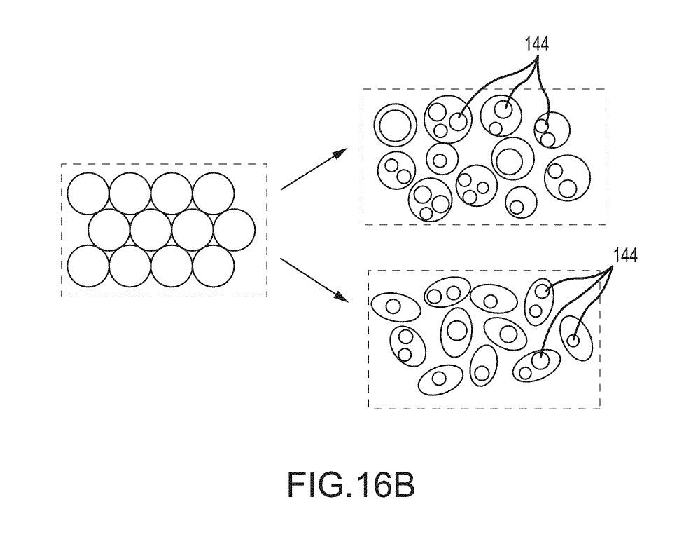

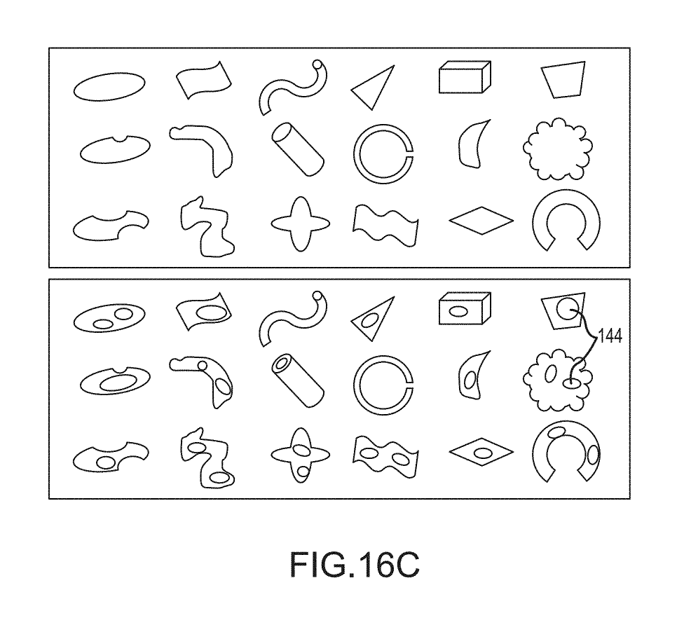

Examples of such AMORPHOUS ARRAY structures are described below. The following drawings and micrographs in FIG. 16A and other ensuing drawings describe the above concept of AMORPHOUS ARRAY structured nanoparticle assembly having lower thermal conductivity together with high optical transparency (low haze problem), as well as various methods of fabricating hollow or solid nanoparticles as components of such structures, methods for preparing stacked layers of nanoparticles, techniques for reducing undesirably large-sized defects using deformation and other methods to improve optical transparency.

In order to exploit the AMORPHOUS ARRAY structured polymer nanoparticles for enhanced porosity and reduced thermal conductivity, certain particle size conditions have to be met. For example, if the particle size distribution is very wide, it will allow smaller particles to fill the gaps between larger particles and undesirably decrease the porosity. Therefore, there is a finite particle size difference that needs to be mandated in order to make a good use of the AMORPHOUS ARRAY structure for enhanced thermal insulation.

According to the present disclosure, the desired polymer particle size difference among the 90% volume of the particles in the polymer assembly structure of e.g., the top right panel of FIG. 16A type AMORPHOUS ARRAY structure, is at least 10%, preferably at least 20%, even more preferably at least 30% so as to introduce additional porosity and reduced thermal conductivity, while the portion of the smaller particles having a diameter less than one-half of the average particle size in the material should be kept minimal, less than 50% volume, preferably less than 30%, even more preferably less than 15%.

The AMORPHOUS ARRAY structure, according to the present disclosure, can also be made by utilizing an intentionally made irregular shaped (non-spherical) nanoparticles (140), as illustrated in the bottom right panel of FIG. 16A. This irregular shaped particle structure also desirably increases the porosity as a dense compact stacking becomes difficult, and hence is helpful in reducing the thermal conductivity. There are many different shapes of irregular geometry. Some examples of which are given in FIG. 16C. According to the present disclosure, the desired irregular particle (140) can be defined as the aspect ratio of the longest dimension to shortest dimension in the oblong, cylindrical, rectangular or random geometry being at least 1.1, preferably at least 1.3, more preferably at least 1.5. If the irregular shape is other than oblong, cylindrical, rectangular or random geometry, the degree of irregular shape can be defined as having at least one corner of the shape having a radius of curvature of 50 nm or less, preferably 30 nm or less, even more preferably 20 nm or less.

Other irregular polymer particle structures (e.g., interconnected phase geometry or pores and the polymer phase intermingled) can also be used as long as the defects and voids dimensions are on the order of the nanoparticle dimension (e.g., <100 nm).

Both the non-uniform-diameter spherical polymer particles (142) (top right panel of FIG. 16A) or by irregular-shaped polymer nanoparticles (140) (bottom right panel of FIG. 16A) create additional porosity as illustrated in the figure. Such porosity desirably reduces the thermal conductivity of the polymer structure. The desired porosity in the AMORPHOUS ARRAY polymer nanoparticle assembly created by non-uniform-diameter or irregular-shape is preferably at least 30%, more preferably at least 45%, even more preferably at least 60%.

The spherical (with non-uniform diameter) or irregular shaped polymer nanoparticles (142), according to the present disclosure, can also contain one or more internal pores (144) added inside of polymer nanoparticles, as illustrated in FIG. 16B, for additional porosity, reduced thermal conductivity and enhanced optical transparency. The left panel of FIG. 16B depicts spherical uniform-diameter particles; the top right panel of FIG. 16B depicts spherical and non-uniform-diameter particles but with one of more internal pores (144), and the bottom right panel of FIG. 16B depicts irregular shaped particles with one or more internal pores (144).

### Embodiment Structure Type K: Irregular-Shaped, Non-Periodic, AMORPHOUS ARRAY Structured Polymer Nanoparticle Assembly for Enhanced Porosity and Improved Thermal Insulation

Polymer materials suitable for this embodiment can be selected, according to the present disclosure, from the list of materials including (but not restricted to) polymethylmethacrylate (PMMA), polyethylene terephthalate (PET), polystyrene (PS), polypropylene (PP), polyester (PES), polyethylene (PE), polytetrafluoroethylene (PTFE), polydimethylsiloxane (PDMS), polyvinylidene fluoride (PVDF), Polyethylene naphthalate (PEN), Polybutylene terephthalate (PBT), and co-polymer thereof and any combinations thereof.

Shown in FIG. 16B is a polymer nanoparticle assembly structure which also incorporates additional internal pores, either a single hollow pore or a multiple pores. The schematic in the top right panel of FIG. 16B represents near spherical polymer nanoparticles containing internal pores, while the diagram in the bottom right panel of FIG. 16B describes internal pores (144) in irregular-shaped (non-spherical) polymer nanoparticles. Such internal pores (144) add more porosity to the polymer particle assembly so as to provide desirable lowered thermal conductivity. The desired porosity in these internally-pored AMORPHOUS ARRAY polymer nanoparticle assembly created by non-uniform-diameter or irregular-shape is preferably at least 30%, more preferably at least 45%, even more preferably at least 60%.

Shown in FIG. 16C is a schematic representation of some possible irregular shaped polymer particles or their two-dimensional projections, which can be useful for increased porosity in AMORPHOUS ARRAY structured particle assembly. These irregular shaped polymer particles can be solid (see the top panel of FIG. 16C) or they can also have one or more internal pores (144) to desirably further increase the porosity, as in the bottom panel of FIG. 16C.

This also provides a random, non-periodic (which is also referred to herein as an “AMORPHOUS ARRAY” structured) nanoparticle polymer assembly. Other irregular structures (e.g., interconnected phase geometry or pores and the polymer phase intermingled) can also be used as long as the defects and voids dimensions are on the order of the nanoparticle dimension (e.g., <100 nm).

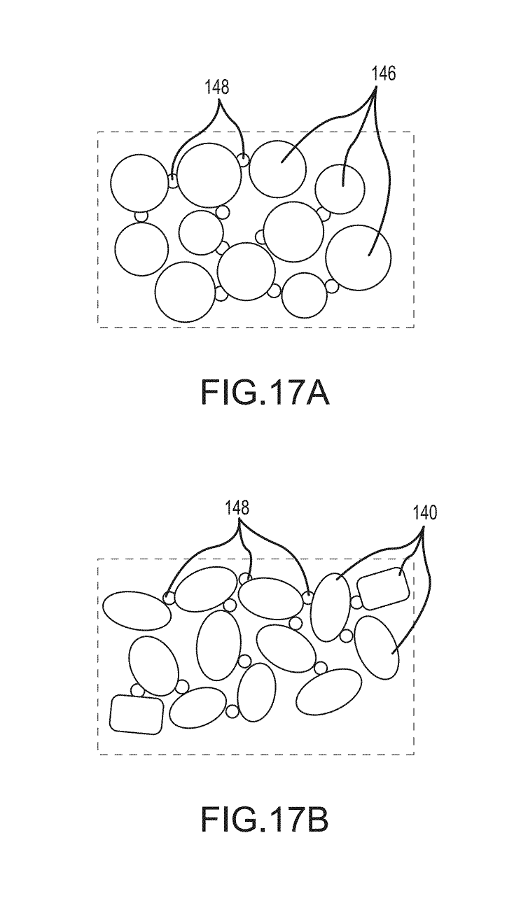

Referring to the drawings, the diagrams in FIGS. 17A and 17B describe one way of how the polymer nanoparticles can be connected to become mechanically more robust AMORPHOUS ARRAY structured polymer nanoparticles. The polymer nanoparticles with non-uniform diameters (146) are physically connected to a more robust AMORPHOUS ARRAY by using smaller diameter particles as bridging elements (148), as shown in FIG. 17A. Similar connections (148) for irregular shaped polymer particles (140) are shown in FIG. 17B. With respect to FIG. 17B, the polymer nanoparticles (140) can be selected from various types of polymers such as polystyrene or PMMA, etc. The connecting material (148) can be of the same glass transition temperature Tg polymer sinter bonded, or a lower Tg polymer fused by light heating, or an adhesive polymer like epoxy, etc.). The bridging polymer nanoparticles (148) can be selected from various types of polymers such as polystyrene or PMMA. The connecting material (148) can be of the same glass transition temperature Tg polymer sinter bonded, or a lower Tg polymer fused by light heating, or an adhesive polymer like epoxy, etc.).

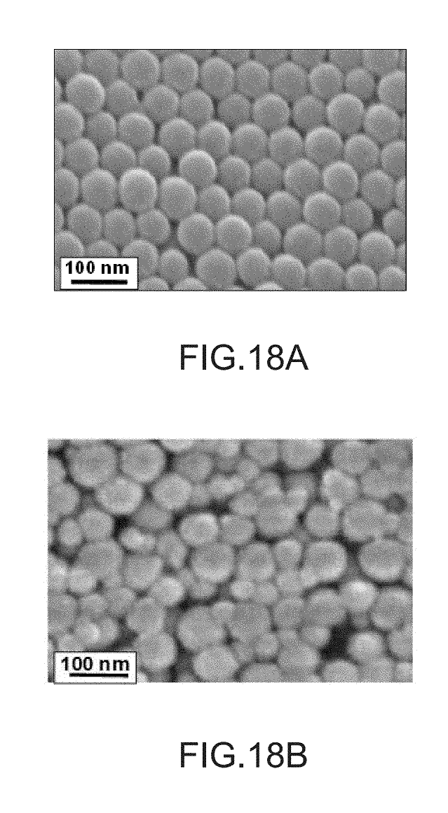

FIGS. 18A and 18B depict examples of comparative microstructures of polystyrene (PS) nanoparticle arrays. Shown in FIG. 18A is an essentially periodic array of mostly equi-diameter nanospheres, and in FIG. 18B an amorphous and random array structure by non-uniform diameter PS nanospheres which results in many point-defect-like defects or voids that can provide increased porosity and reduced thermal conductivity is shown. This random structure with small sub-wavelength-sized defects provides a transparent film at ˜20 μm thickness after dip coating on glass slides.

Some actual scanning electron microscopy (SEM) microstructures for the uniform diameter vs non-uniform-diameter polymer nanoparticle arrays are presented in FIGS. 18A and 18B. A polystyrene (PS) nanoparticle array showing an essentially periodic and compact array of mostly equi-diameter nanospheres is presented in FIG. 18A, showing less defects but only ˜26% porosity, while FIG. 18B represents non-uniform diameter PS nanospheres which results in a less compact assembly having many more voids and increased porosity for reduced thermal conductivity. In FIG. 18B, there is a variation in particle size of between 30-70 nm, reducing local-close-packing and intentionally introducing more pores toward ˜50-60% (for Knudsen-Effect-reduced air thermal conductivity. This AMORPHOUS ARRAY structure with small sized porosity (which can be viewed as sub-wavelength-sized optical defects) produced an optically transparent film at ˜20 μm thickness after dip coating on glass slides.

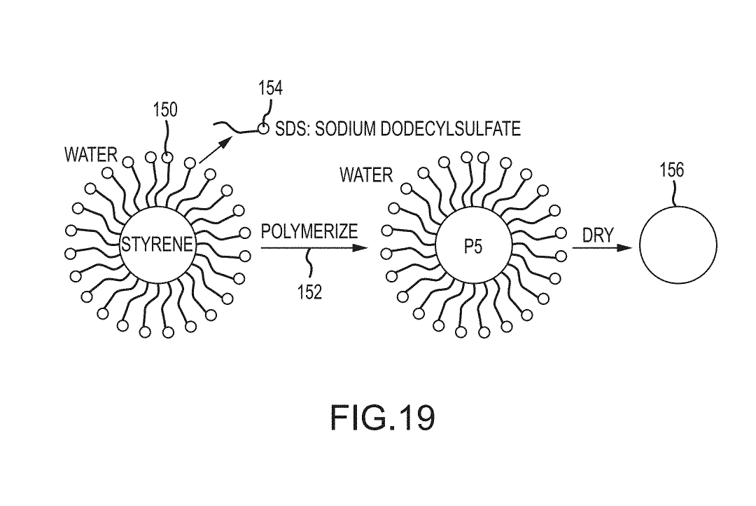

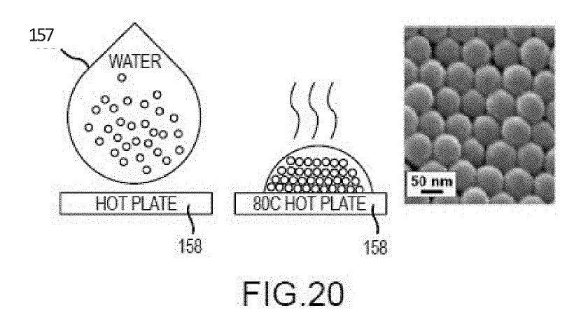

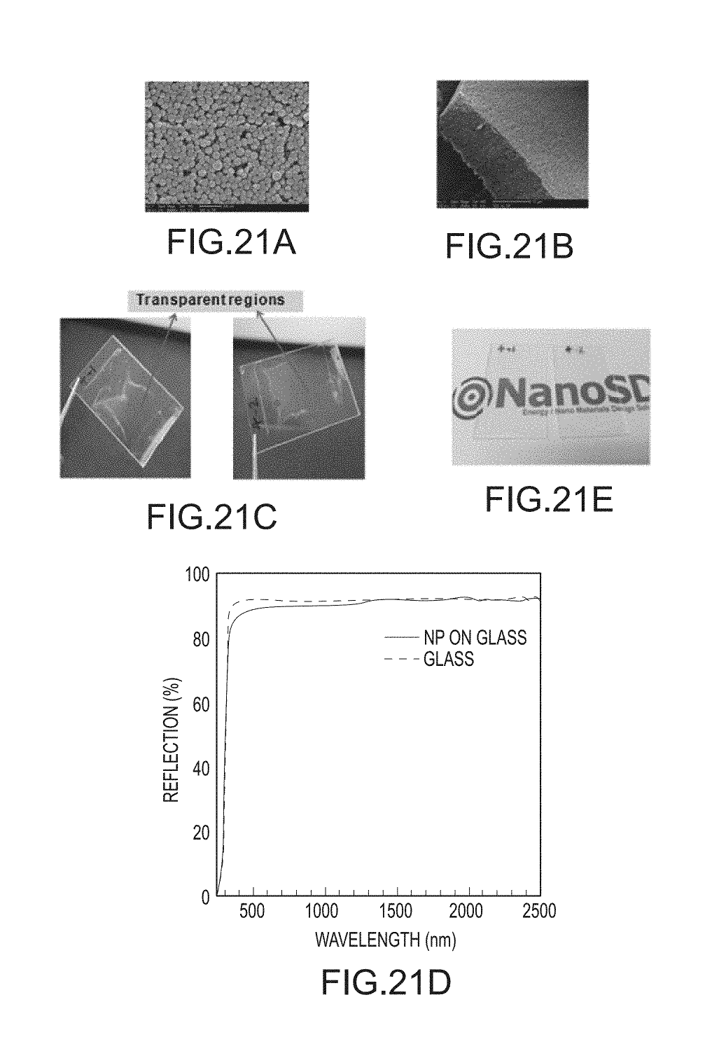

Shown in FIG. 19 is an example synthesis method for polystyrene (PS) nanospheres (156) using a Micelle reaction (oil-in-water emulsion) using polymerization (152) of styrene monomer (150) with SDS (sodium dodecyl sulfate) surfactant (154). The PS particle size is decided by the concentration of SDS, polymerization temperature, stirring power for the solution during reaction, and concentration of initiator. Presented in FIGS. 20 and 21 are example uniform diameter PS particle assembly and non-uniform-size PS particle assembly, respectively. In FIG. 20, a close packed nanosphere stacking by surfactant is obtained by evaporative deposition using SDS (sodium dodecyl sulfate) surfactant on polystyrene nanospheres (˜67 nm dia). The surfactant provides a repellent force between adjacent polymer nanoparticles to enable close packing of PS nanospheres during drying. The wet PS and water mixture (157) (or PS and other liquids like alcohols) is dried by using a heater (158) for heating from the bottom because a drying process from the top surface side tends to cause a delamination, cracking/microcracking or other complications.

In FIG. 21A, polystyrene non-uniform particle size distribution of 30-70 nm dia range produces an AMORPHOUS ARRAY structure over a larger area. Some small-sized porosity of 10-60 nm dimension desirably contributes to the Knudsen-effect-reduction of thermal conductivity. An optically transparent film is obtained at 15˜20 μm layer thickness (FIG. 21B) after dip coating on a glass slide, as the defects that contribute to light scattering (haze) are quite small, mostly in the sub-wavelength-regime as compared to the visible spectrum range.

Shown in FIG. 21C through 21E are photograph and optical behavior of ˜20 μm thick polystyrene particle AMORPHOUS ARRAY structure layer, which indicates an excellent optical transmission and reasonably low haze. FIG. 21C depicts polymer nanoparticle array layer samples showing optical transparency, FIG. 21D depicts optical reflectivity of nanoparticle (NP) sample vs wavelength, and FIG. 21E depicts a transparent polymer nanoparticle layer sample super-imposed on letterings to demonstrate the optical transparency.

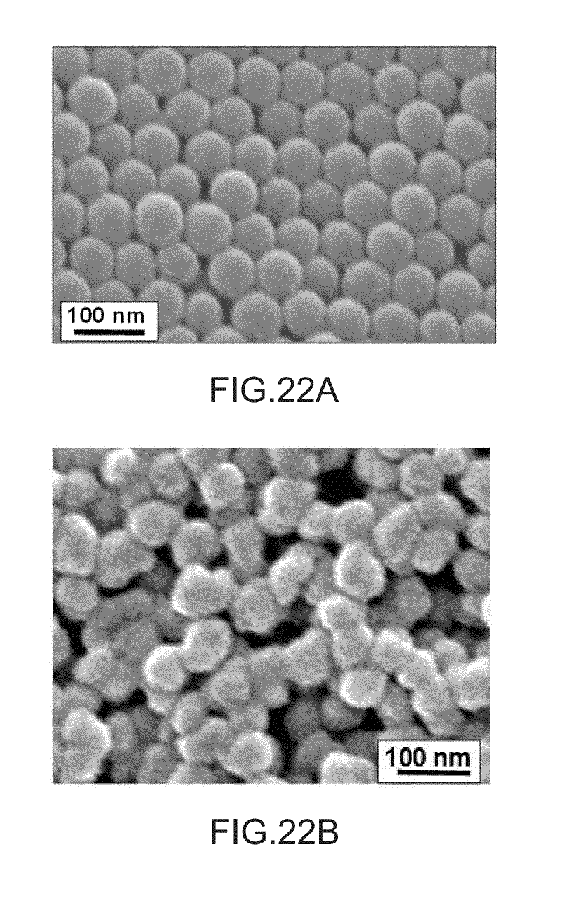

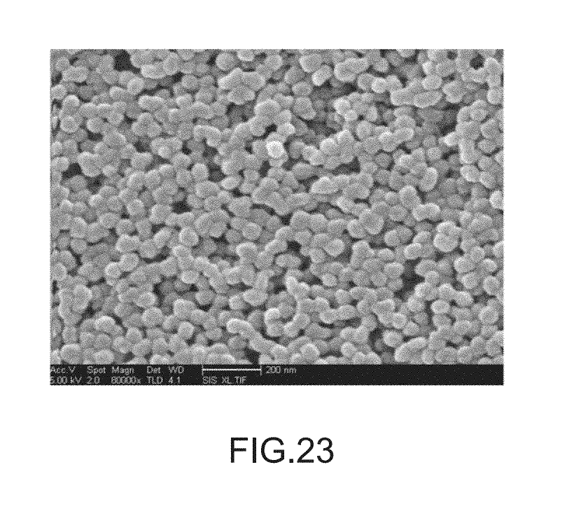

In FIGS. 22A and 22B, comparative SEM micrographs of example polystyrene (PS) nanoparticle arrays are presented showing essentially periodic array or densely packed, mostly equi-diameter nanospheres (FIG. 22A) showing more uniform size, spherical PS nanoparticles showing less defects but only ˜33% porosity, and an AMORPHOUS ARRAY, random structure by adopting irregular shape PS nanoparticles (FIG. 22B), with irregular shape PS nanoparticles reduce local-close-packing and intentionally introduce more powers toward ˜50% or more porosity (for Knudsen-Effect-reduced air thermal conductivity). This structure results in many point-defect-like defects or voids that can provide increased porosity and reduced thermal conductivity. Such an AMORPHOUS ARRAY structure with an average ˜60 nm diameter PS nanoparticles with irregular (less spherical) particle shape is maintained over a large area of the sample as shown in FIG. 23, This random arrangement with small-size porosity having sub-wavelength dimensions can produce transparent films. The enhanced amount of pores due to the irregular nanoparticle geometry leads to desirably reduced thermal conductivity.

It is important to minimize polymer nanoparticles, as the smaller particles are helpful for reducing the size of defects such as aggregated voids greater than 100-200 nm diameter, which can cause undesirable haze effect and loss of optical transparency.

FIG. 23 depicts a low magnification SEM micrograph that shows an AMORPHOUS ARRAY structure of ˜60 nm diameter PS nanoparticles with irregular (less spherical) particle shape distribution over a larger area. The porosity size is also desirably small, on the order of 20-100 nm, well within the subwavelength regime.

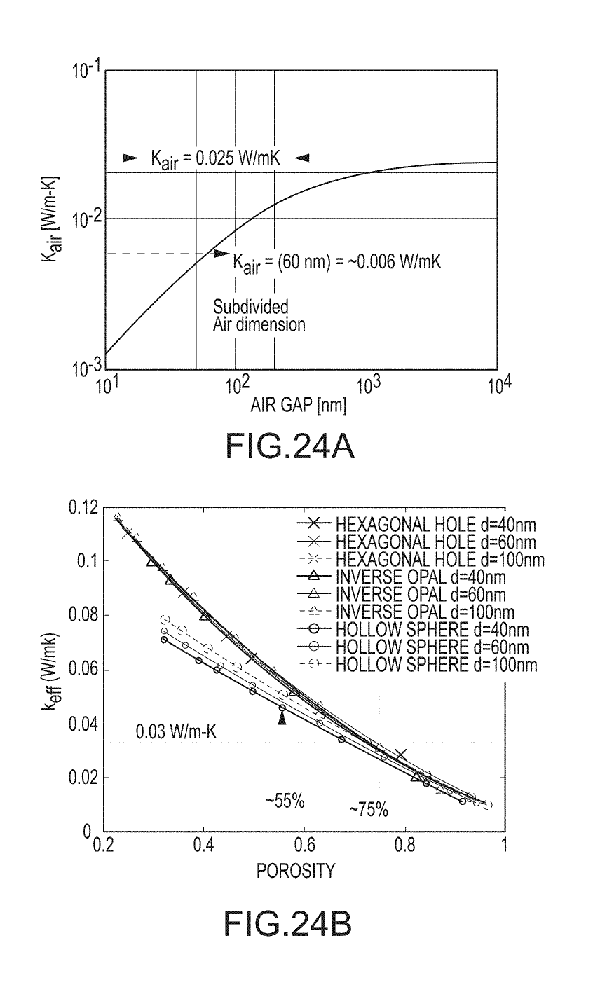

FIGS. 24A and 24B depict thermal conductivity estimation. FIG. 24A depict how a subdivision of air (e.g., via the presence of small porosity) reduces the thermal conductivity of air, and FIG. 24B depicts thermal conductivity vs. porosity curves (by calculation modeling) for various polymer nanoparticle and nanopore arrangements. If sufficient nano porosity can be made by AMORPHOUS ARRAY structured nanoparticles (using either non-uniform diameter nanoparticles or irregular geometry nanoparticles), e.g., to the level of 55 to 60% porosity, the thermal conductivity can be reduced to the excellent insulator regime of 0.05 W/m·K or less.

Shown in FIGS. 24A and 24B are the estimated thermal conductivity of subdivided air (e.g., via the presence of small porosity) which reduces the thermal conductivity of air (FIG. 24A), and the estimated thermal conductivity vs. porosity curves (by calculation modeling) for various polymer nanoparticle and nanopore arrangements of polymer nanobubbles and polymer inverse opal structures of FIGS. 1C), 2D, and 3. As shown in FIG. 24B, if sufficient nano porosity can be made by AMORPHOUS ARRAY structured nanoparticles (using either non-uniform diameter nanoparticles or irregular geometry nanoparticles), e.g., to the level of 55 to 60% porosity, the thermal conductivity can be reduced to the excellent insulator regime of 0.05 W/m·K or less as can be seen from the upward pointing arrow starting from ˜55% porosity position. If the pore size is kept small in the subwavelength regime, as in the case of this disclosure for the AMORPHOUS ARRAY structures, a desirably low thermal conductivity together with a desirably reduced haze can be obtained.

### Embodiment Structure Type L: Elongated Particle Shape AMORPHOUS ARRAY Structured Polymer Nanoparticle Assembly for Enhanced Porosity and Improved Thermal Insulation

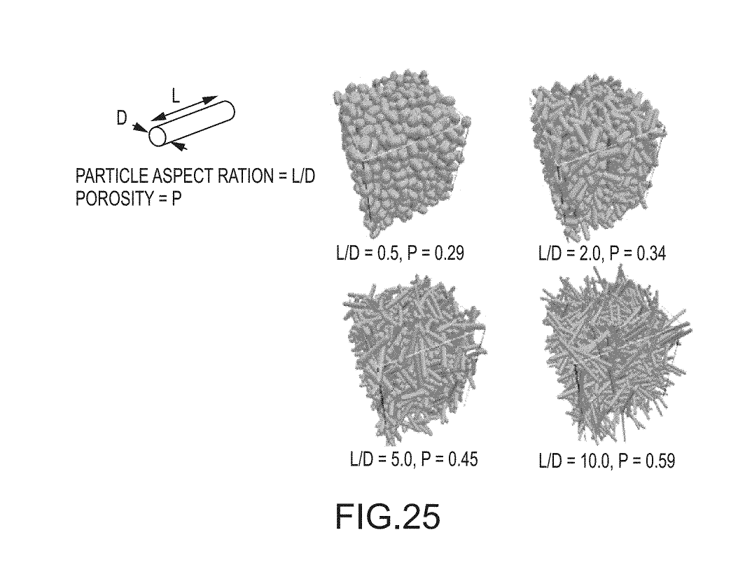

When the irregular shaped particles are stacked, the degree of elongation of the irregular particles influences the formation of pores and the overall amount of porosity. Shown in FIG. 25 is the effect of particle elongation aspect ratio L/D on porosity P. Increased aspect ratio of the elongated particles (cylinder shape in this case) reduces the packing density and increases the porosity. To reduce the packing density and increase the porosity, the L/D aspect ratio should be maximized. For an optically transparent, low-haze polymer particle layer, defects (such as a void with a size greater than 100-200 nm) should be minimized, so too high a aspect ratio is not desirable from the haze point of view. The range of desired polymer particle elongation aspect ratio is in the range of 1.5-10, preferably in the range of 2-5.

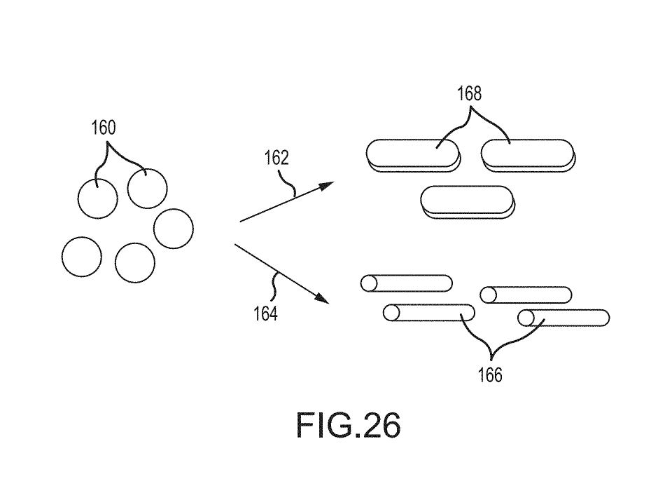

Polymer particle elongation is not commonly observed. According to the present disclosure, the polymer nanoparticles can be intentionally elongated so as to increase the porosity of particle stack structure and reduce the thermal conductivity. Shown in FIG. 26, are some example methods to elongate the polymer nanoparticles. The nanoparticles (160) are, e.g., pre-embedded in a dissolvable thermoplastic matrix like honey, dextrin, sugar, or some selected solidified surfactant such as Pluronic P-123 surfactant, encapsulating the composite within a plastically deformable capsule container such as aluminum, copper or high strength thermoplastic polymer tubing, followed by warm rolling type deformation (162) (top right panel of FIG. 26) for shape elongation of the thermoplastic composite. The elongated polymer particles (168) can be retrieved by dissolving away the disposable matrix, e.g., by water or solvent. If a uniaxial type deformation such as swaging, rod rolling, extrusion (preferably warm processing near the Tg of the matrix material) (164), near-rod-like shaped particles (166) are produced which can be retrieved by dissolution of the disposable matrix. Bottom right panel of FIG. 26 depicts elongation by uniaxial deformation such as swaging or rod rolling (warm processing) to produce near-rod-like shaped particles, followed by removal of disposable matrix.

### Embodiment Structure Type M: Cylindrical or Rectangular Particle Shape AMORPHOUS ARRAY Structured Polymer Nanoparticle Assembly for Enhanced Porosity and Improved Thermal Insulation

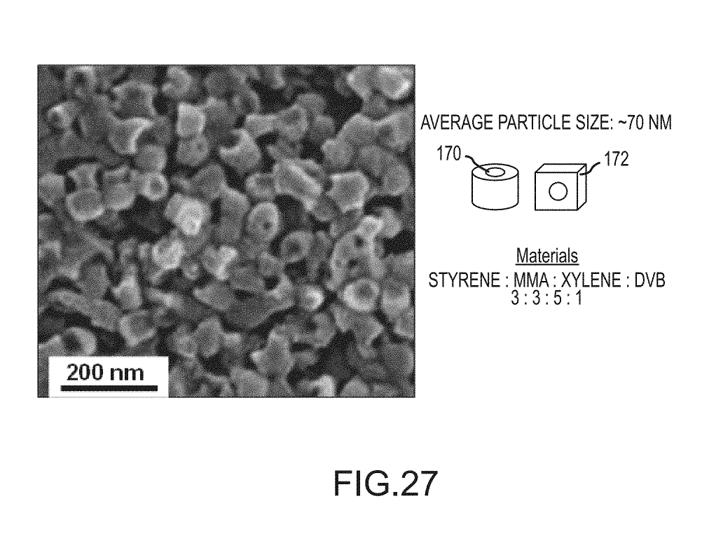

Irregular particle shape such as cylindrical or rectangular particle geometry has been fabricated as in FIG. 27. An assembly of ˜70 nm irregular shaped PS nanoparticles (cylindrical (170) or rectangle (172) shapes) have been made to increase overall porosity and reduce thermal conductivity. The microemulsion synthesis of PS nanoparticles utilized a material mix ratio of Styrene:MMA (methyl methacrylate):Xylene:DVB (Divinylbenzene)=3:3:5:1. The irregular shape of the PS nanoparticles and the presence of internal pores contribute to the desirably lowered thermal conductivity, by at least 10%, preferably by at least 30%, even more preferably by at least 50% as compared to the standard equi-diameter spherical and solid PS nanoparticles. The preferred polymer (e.g., PS, PMMA, PEN, etc.) diameter is in the range of 10-5,000 nm, preferably 20-100 nm, more preferably 20-100 nm.

For emulsion synthesis and assembly into a layer, the Pluronic P-123 surfactant was used. The Pluronic P-123 (PEG-PPG-PEG) symmetric triblock copolymer is made up of PEO (poly ethylene oxide) and PPO (poly propylene oxide) block components. The unique properties of PPO block exhibiting hydrophobicity at temperatures above 288K and solubility in water at temperatures below 288K enables the formation of micelle consisting of PEO-PPO-PEO triblock copolymers. The hydrophobic core contains PPO block, and a hydrophilic corona consists of PEO block. In 30 wt % aqueous solution Pluronic P123 forms a cubic gel phase. The P-123 surfactant has a molecular weight of 5,800 g/mol. Its chemical formula is HO(CH2CH2O)20(CH2CH(CH3)O)70(CH2CH2O)20H. These triblock copolymer surfactants are utilized in this disclosure to form either spherical or cylindrical micelles depending on the synthesis specifics employed.

### Embodiment Structure Type N: Hollow-Hole Particle Shape AMORPHOUS ARRAY Structured Polymer Nanoparticle Assembly for Enhanced Porosity and Improved Thermal Insulation

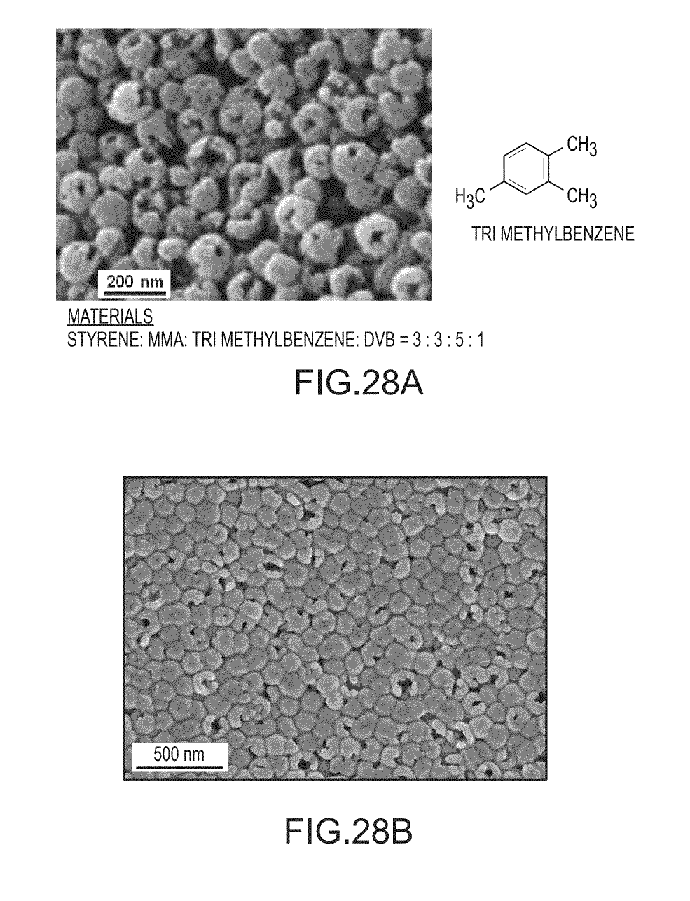

Hollow-holed irregular particle shapes have been fabricated as in FIG. 28A. In this example, ˜150 nm hollow PS nanoparticles with non-uniform diameter have been synthesized to increase overall porosity and reduce thermal conductivity. Both the non-uniformity of particle diameter and the internal pores contribute to the lower thermal conductivity, by at least 10%, preferably by at least 30%, even more preferably by at least 50% as compared to the standard equi-diameter spherical and solid PS nanoparticles. The preferred polymer (e.g., PS, PMMA, PEN, etc.) diameter is in the range of 10-5,000 nm, preferably 20-100 nm, more preferably 20-100 nm. The microemulsion material of Styrene:MMA (methyl methacrylate):Tri Methylbenzene:DVB=3:3:5:1 mix ratio was used for the synthesis.

The mechanism of hollow-hole formation inside PS nanoparticles can be explained as follows. The polystyrene (PS) particles are first swollen by the solvent, in this case xylene (other solvents such as toluene can also be utilized). As a result of solvent absorption and swelling, the PS volume expansion occurs. The state of swollen particle shape is fixed by cryogenic freezing with liquid nitrogen (LN2) or evaporated cold nitrogen vapor to the low temperature well below the freezing point of xylene, (CH3)2C6H4, (−47.4° C.). This freezing step makes the solvent xylene to shrink in volume on transformation into solid xylene, which results in creation of one or more voids inside each of PS nanoparticles.

When the solvent in the particle is removed by drying, more empty space becomes available and the void in the PS particle gets larger. The speed of warming up the frozen polystyrene particles has to be carefully and slowly controlled to remove xylene without damaging the particle shape. The desired rate of warming from the cryogenic temperature is less than 100° C./hr, preferably less than 50° C./hr, even more preferably less than 10° C./hr. There are three other possible xylene isomers of o-xylene, m-xylene, and p-xylene with different freezing points of −25° C., −48° C., +13° C., respectively, but these isomers will also work for a similar process approach if properly processed. According to the present disclosure, the freezing point of the solvent is selected to be as low as possible since lower freezing temperature solvent will evaporate faster at a given evaporation temperature being used so as to make the void larger.

Shown in FIG. 28B is another example of non-uniform sized amorphous structured hollow-hole polystyrene (PS) nanoparticles. However, this structure is more unique in that the adjacent hollow particles are advantageously contacting and are bonded to each other during the synthesis for convenient construction of a thick insulator layer. Both the non-uniform particle diameter and the presence of the internal voids in this type of structures contribute to the reduced thermal conductivity. For the microemulsion synthesis, the materials used are the Pluronic P-123 (PEG-PPG-PEG) symmetric triblock copolymer surfactant 1.875 g dissolved in 100 g water, then added various solutions of 3 ml Styrene, 3 ml MMA, 5 ml indane, DVB 1 ml with 0.1 g KPS) potassium persulfate) for polymerization at 70° C. Similar hollow PS with adjacent spheres bonded can also be obtained by using a mix ratio of Styrene:MMA:Ethylbenzene:DVB=3:3:5:1.

### Embodiment Structure Type O: Control of Haze-Inducing Defects in Polymer Nanoparticle AMORPHOUS ARRAY Structure for Enhanced Optical Properties

For window glass retrofittable insulator film applications, the polymer nanoparticle array structure has to be optically reasonably transparent with minimal haze problem. The haze issue in polymer nanoparticle layer arises because of light scattering by defects. The effect of the defects on haze scattering is dependent on the size and density of light scattering defects such as voids. It is desirable to keep the size of defects in the subwavelength regime.

Deep subwavelength dimensions well below the visible wavelength regime of ˜400-800 nm spectral regions is imperative to remove the haze type deterioration of optical transparency for window applications. The desired size of the defects such as voids has to be less than ½, preferably ⅓, even more preferably ¼ or less of the visible optical wavelength regime of e.g., 400-800 nm. Therefore, the desired defect size is at most 150 nm, preferably at most 100 nm, even more preferably at most 75 nm.

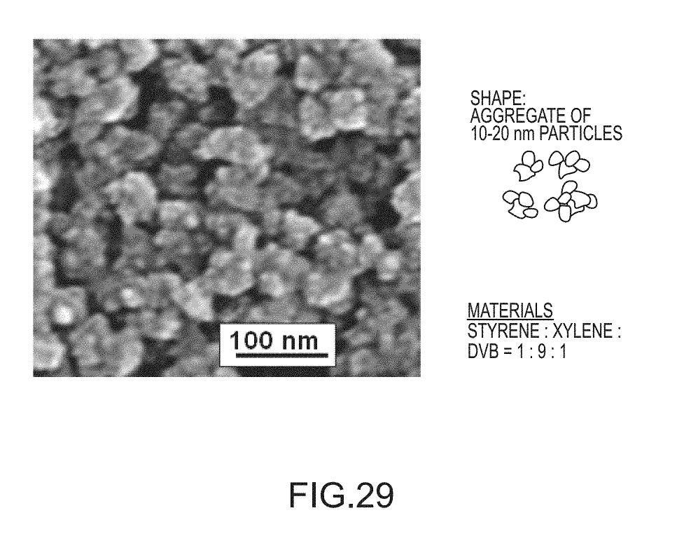

Smaller average polymer nanoparticle sizes are desired as the probability of forming such large voids is also likely to be reduced. According to the present disclosure, if the initial polymer particle size is made smaller, e.g., 20 nm or smaller and are AMORPHOUS ARRAY structured with irregular particle shape, sufficient nanoporosity of 50-60% could be obtained for sufficient reduction in thermal conductivity. When the base particle size is made smaller, the defects that occur during particle stacking also tend to get smaller, thus overall haze problem gets minimized. Shown in FIG. 29 is an SEM micrograph describing the synthesis of very small size, sub-20 nm polystyrene nanoparticles having irregular shape. The further size-reduced polystyrene nanoparticles are synthesized by microemulsion technique using Styrene:Xylene:DVB (Divinylbenzene)=1:9:1 ratio, with P-123 as a surfactant. (1.875 g P-123 dissolved in 100 g water+1 ml Styrene, 9 ml Xylene, DVB 1 ml, with 0.1 g potassium persulfate (KPS) for polymerization initiation at 70° C.). For surfactant, P-123 non-ionic surfactant was used (1.875 g P-123 dissolved in 100 g water+1 ml Styrene, 9 ml Xylene, DVB 1 ml, with 0.1 g potassium persulfate (KPS) for polymerization initiation at 70° C.

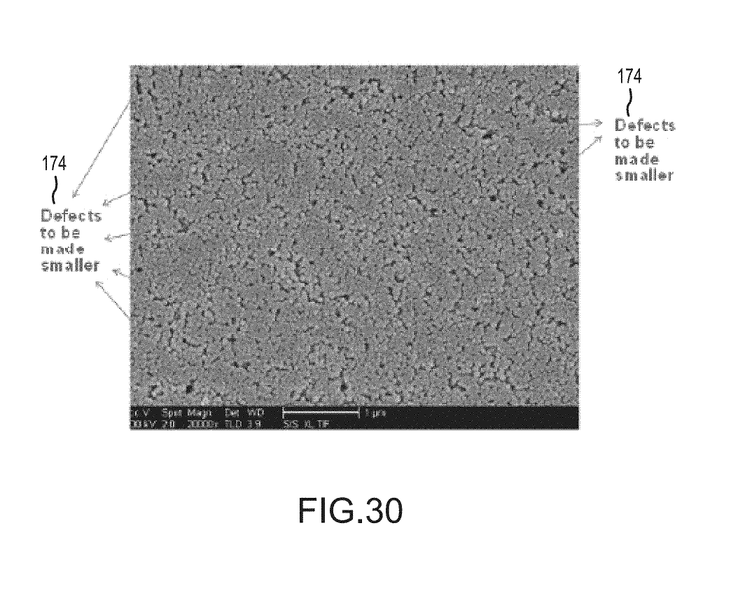

FIG. 30 depicts an SEM micrograph of non-uniform diameter, amorphous structured polystyrene nanoparticles (˜60 nm size regime), with rather small size defects/voids. However, there are some large defects/voids (174) of ˜200 nm or larger size, which need to be removed in order to obtain low haze, high transparency PS layers. Cold rolling, pressing/squashing or related deformation methods can be utilized to squeeze out or squash these large undesirable defects.

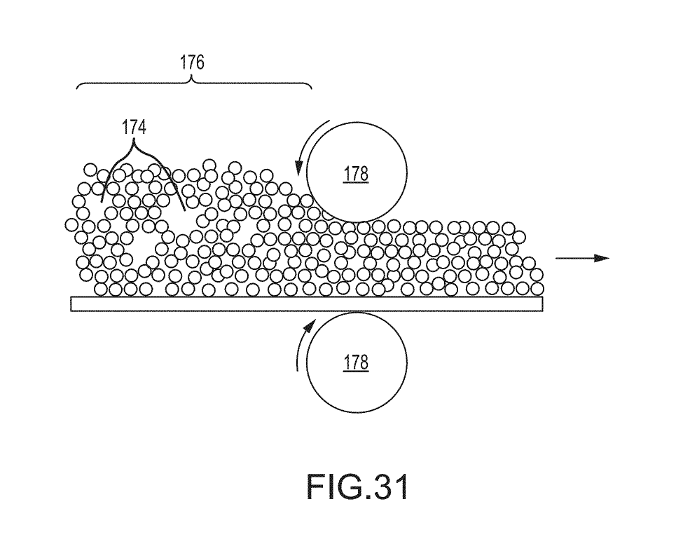

In case there are stacking defects (voids) greater than the sub-wavelength dimensions (174) (e.g., 100-200 nm size, see FIG. 30) the present disclosure teaches a novel technique of reducing the size of such large voids by compacting deformation to below subwavelength regime (e.g., to 30-100 nm size), as described in FIG. 31. It is important to minimize the size of defects such as aggregated voids greater than 100-200 nm diameter (174) so as to reduce optical haze. Shown in FIG. 31 is one exemplary method to reduce the number of undesirably large (>100 nm or >200 nm) defects (174) (e.g., vacancies, dislocations, missing lines, cracks that can cause severe haze problems) by cold rolling or warm rolling compression. As depicted in FIG. 31, a polymer nanoparticle layer with stacking defects (176, 174) is pulled forward through compression rollers (179) which squeeze out and remove the large stacking defects (174). Other techniques such as mechanical compression, laterally-sweeping-compression, or rolling type deformation of the nanoparticle stack (having irregular diameter or irregular shape) can remove the larger, undesirable defects (174) that can cause haze-type transparency reducing problems. Note that the small defects with dimensions near the ˜50 nm regime nanoparticle diameter or smaller (harmless from the haze point of view as these are too small to cause haze) are actually retained as they are needed to provide a sufficient porosity to reduce the thermal conductivity and enhance thermal insulation. According to the present disclosure, the number of void defects having 150 nm or larger size is reduced by a factor of at least 2, more preferably by a factor of at least 5.

### Embodiment Structure Type P: Improved Polymer Nanoparticle Stacking Method

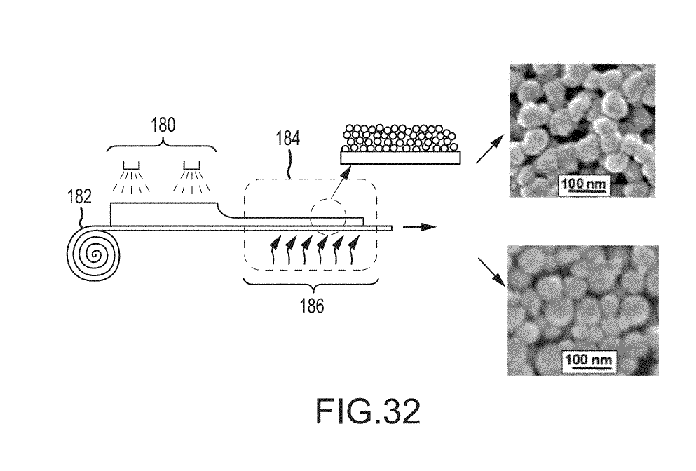

Shown in FIG. 32 is an example method to rapidly produce a polymer nanoparticle layer by multi-nozzle spray (180) coating of irregular-shaped or size-varying 30˜60 nm PS or PMMA nanoparticles in colloidal solution (with a selected surfactant). It is sprayed onto a substrate (182) which is continuously pulled forward. Curing of the polymer nanoparticle layer by ˜90° C. oven (184), heating coil array (186), IR heat, hot metal block, hot air blow, or other heating method known in the art is also conducted. Other coating methods such as dip coating or brush-coating, ink-jet coating, spin coating and their combinations may also be utilized, but a continuous spray coating deposition is amenable to a high throughput manufacturing process.

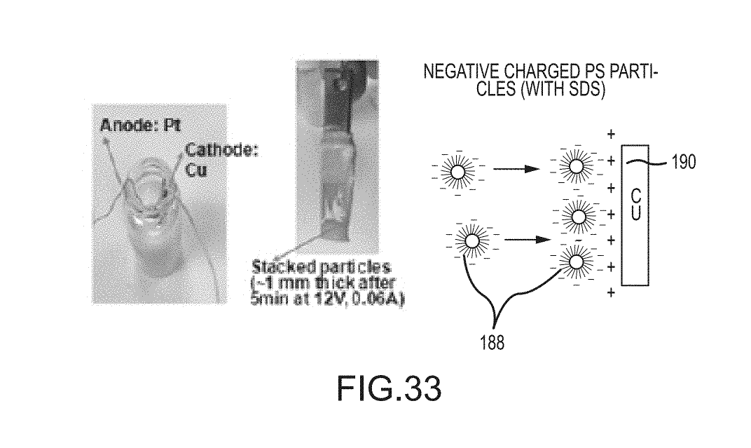

Shown in FIG. 33 is an alternative method of rapidly achieving a polymer nanoparticle layer accumulation by electrolytic stacking or electrophoretic deposition of charged polymer nanoparticles. The surface of the polymer nanoparticles such as PS (polystyrene), PEN or PMMA is altered, e.g., by surfactant ions (e.g., SDS), to have negative or positive surface charge (188). Applying electric field makes the charged particles to move to the opposite polarity electrode (190) to form a thick layer. This technique of nanoparticle deposition into a thick layer can also be performed using a continuous or continual processing, e.g., by continuously feeding a plastic substrate sheet, ribbon or roll into the electrolytic stacking bath, while the coated sheet is retrieved and wound on the other side onto a take-up wheel. Additional needed steps, such as drying, curing, or adhesion-enhancing process are added before the sheets/ribbons are wound into the roll.

### Embodiment Structure Type Q: Methods for Synthesis of Hollow Polymer Nanoparticles

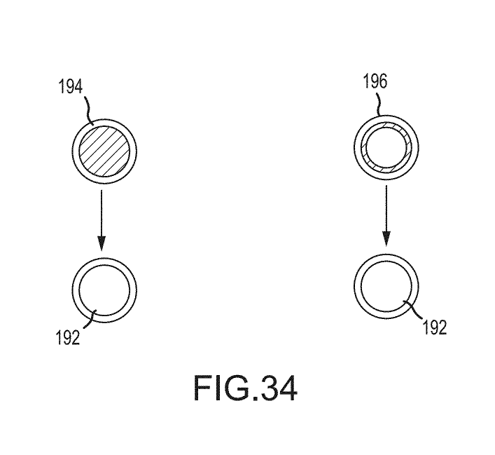

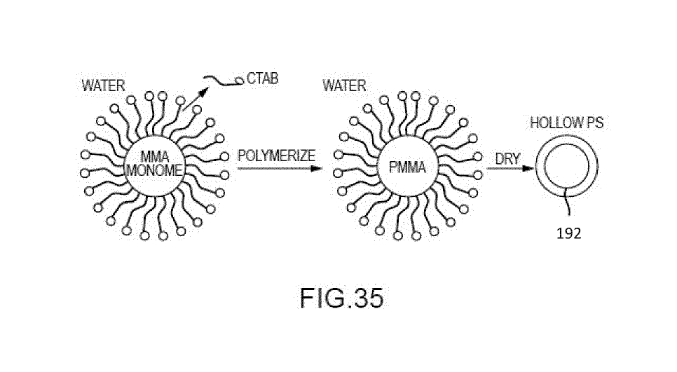

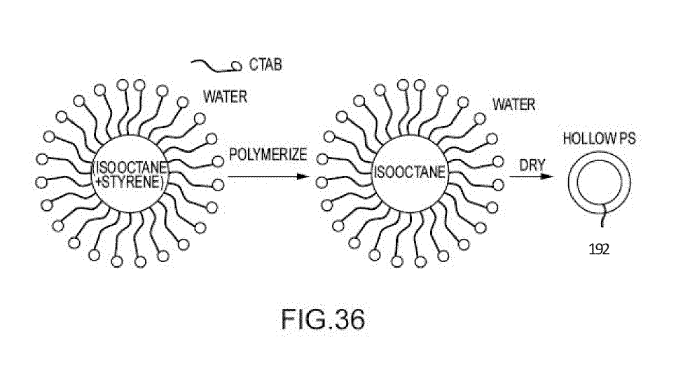

Hollow polymer nanoparticles are useful for low thermal conductivity thermal insulator layers. There are several methods of synthesizing such hollow polymer particles in addition to the microemulsion type synthesis. Shown in FIG. 34 are other methods of preparing hollow polymer nanobubbles (192) by using solid silica nanoparticles (194) or hollow silica nanoparticles (196) as removable sacrificial templates. A desired polymer is coated as the shell and the silica core is dissolved away. The use of hollow silica core (196) makes it much easier and faster to etch away the core and produce the hollow polymer sphere such as polystyrene or PMMA. Shown in FIG. 35 and FIG. 36 are synthesis methods for hollow polystyrene nanoparticles using a solid PMMA nanosphere core (FIG. 35) or using liquid iso-octane core (FIG. 36) and CTAB as a surfactant. In each method, the core is polymerized with CTAB surfactant and then dried to result in hollow polystyrene nanoparticles

### Embodiment Structure Type R: UV-Resistant Window Insulator

UV radiation of polymers such as polystyrene causes photo oxidative degradation which causes the breaking of the polymer chains, produces radicals and reduces the molecular weight. This leads to deterioration of mechanical properties.

For resistance to UV for long term protection against photo degradation by absorbed UV light such as discoloring or mechanical deterioration, the present disclosure utilizes various approaches.

One aspect of present disclosure discloses an embodiment of adding a UV-preventing coating such as UV-absorbing coating on the outer surface of the nanobubble polymer window insulator layer (the surface facing the window glass) or the other (facing inside) surface. The UV absorbing-coatings can also be applied on the window glass itself so as to cut-off the UV light before it enters the building inside.

Another aspect of the present disclosure is to stabilize the polymer chains by utilizing a stabilizer. Complexes of 2-thioacitic acid benzothiazol can be used as additives to increase the photostabilization of polystyrene.

UV preventing (absorbing) coating can also be applied to the nanopolymer insulator layer or on the window glass itself. UV absorbing coating be inorganic or organic.

Inorganic coatings include thin film materials such as TiO₂, CeO₂, ZnO which can be deposited by physical vapor deposition, chemical vapor deposition, or sol-gel type coating.

The organic coating UV absorbers are desirably essentially transparent with high absorption coefficients in the UV range of the spectrum. The UV-absorber coating molecules consume the absorbed energy into less harmful energy before reaching the substrate. An example organic UV-absorber molecules include a phenolic group compounds often forming O—H—O bridges, such as salicylates, 2-hydroxybenzophenones, 2,2′-dihydroxybenzophenones, 3-hydroxyflavones or xantones and compounds forming O—H—N bridges, such as 2-(2-hydroxyphenyl)benzotriazoles and 2-(2-hydroxyphenyl)-1,3,5-triazines. See an article by Marcos Zayat et al, “Preventing UV-light damage of light sensitive materials using a highly protective UV-absorbing coating”, Chem. Soc. Rev., 2007, Vol. 36, page 1270-1281 (2007), and an article by Yousif and Haddad, “Photodegradation and photostabilization of polymers, especially polystyrene: review”, SpringerPlus, Vol. 2, page 398 (2013). For protection of polystyrene layer from UV light, known UV absorbers such as 2-hydroxy-4-methoxybenzophenone, Tinuvin 327, hydroxyl phenyl pyrazole, thiadiazole compounds, dihydroxyphenylpyrazoles, can be utilized as an additives or as a coating onto the nanopolymer insulator layer, according to the present disclosure.

For improved durability, the nanopolymer insulator layers based on either periodic nano-bubble structure, inverse nano-opal structure, AMORPHOUS ARRAY structured nanopolymer structure, especially for window glass insulation type applications, UV resistant coatings in the range of 10-500 nm or UV-resistant additives in the composition range of 0.1-5 atomic % can be optionally employed. However, for disposable type insulator applications with desired environmental degradability, e.g., coffee cups, packing materials, take-out food boxes, such a UV-resistant modifications are not desired.

### Embodiment Structure Type S: Environment Friendly Nanopolymer Insulator

Some polymer materials are very stable and can last many hundreds of years without degrading, which is not always desirable, as human garbage keep accumulating on earth even after burying under the ground. Burying garbage can also cause pollution of both water and air. Even buried in a landfill, many typical types of plastic trash bags take 1,000 years to degrade, and when they decompose, they sometimes release toxins.

Therefore, another aspect of the present disclosure is the design and development of environmentally friendly polymer nanobubble insulators. Good thermal insulating polymers such as expanded polystyrene polymers (well known as Styrofoam) have been widely used for hot coffee cups, take-out food containers, and packing/shipping filler materials. However, the long-lasting stability of styrofoam microbubble insulator is of concern because of environmental and health concerns of styrofoam, thus its use has become a major social issue and it has been banned in many cities.

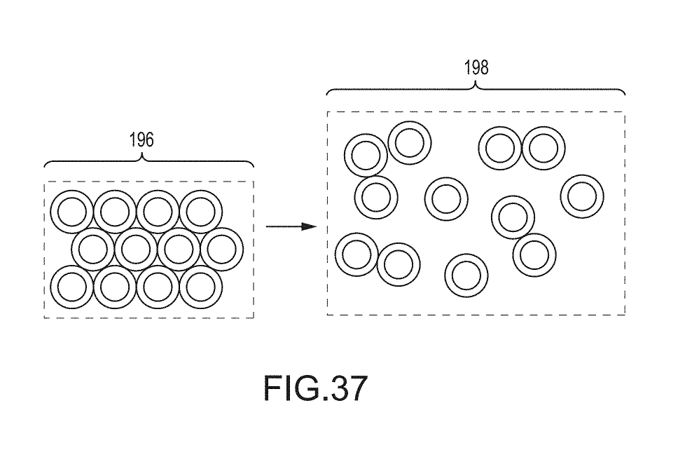

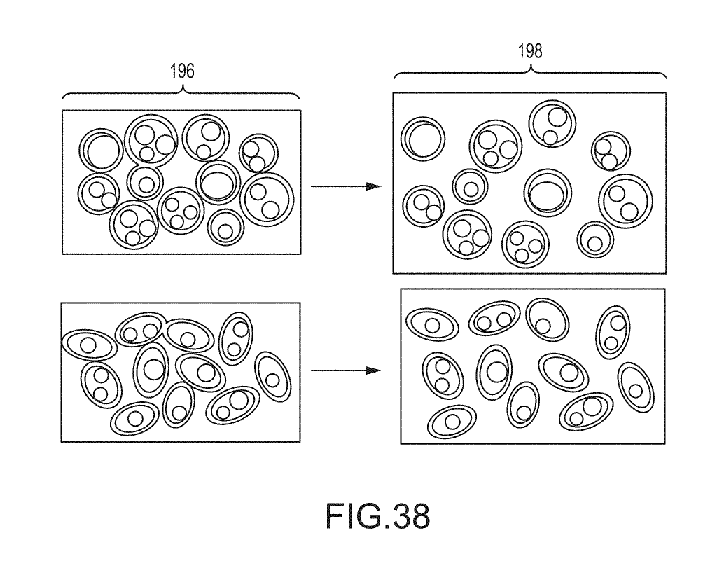

Shown in FIGS. 37 and 38 are example configurations of environment-friendly, degradable polymer nanobubbles. Such degradable structures (196) are also applicable for the nanopolymer insulators having internal pores for reduced thermal conductivity (see FIG. 38). Described in FIG. 37(a) and FIG. 38(a) is a polymer nanobubbles structure (196) with dissolvable or degradable interface materials such as surfactants (e.g., Pluronic P123 made of PEO-PPO-PEO block co-polymer surfactant, SDS (Sodium dodecyl sulfate), CTAB (centrimonium bromide), adhesive coat (e.g., dextrin, honey, gelatins, polysaccharides polyvinyl alcohol, other adhesives), or biodegradable polymers often consisting of ester, amide or ether bonds, such as polyglycolic acid (PGA), polylactic acid (PLA), Poly(lactic-co-glycolic acid) (PLGA), polyhydroxy butyrate (PHB), poly-hydroxybutyrate-co-b-hydroxy valerate (PHBV), or polycaprolactones (PCL).

The drawings shown in the right-side portion of FIGS. 37 and 38 depict the desirably degraded and disintegrated structure (198) after environmental exposure to air, soil, water, UV light, temperature change, etc. The environmentally more degradable nano-polymers in this disclosure contain surfactant or interfacial adhesive layers intentionally added that are degradable over many years of environmental exposure, e.g., UV, water, temperature, mechanical strain, and so forth. The addition of the degradable material can be to envelope individual nanoparticles or sporadically added to a group of polymer nanoparticle aggregates. The amount of intentionally added environmentally degradable surfactants or adhesives is in the range of 0.1 to 50% by volume, preferably 1-20%, even more preferably 1-10%.

According to the present disclosure, the environmentally degradable nano-polymer insulators (either based on periodic polymer nanobubble insulator layers, inverse nano-opal insulator layers, or AMORPHOUS ARRAY polymer nanoparticle structured insulator layers) exhibit substantially improved environmental degradability by disintegration into smaller pieces at a faster rate of at least 2 times, preferably at least 5 times, even more preferably at least 10 times, as compared to regular plastic insulator layers without nano-polymer structures.

### Embodiment Structure Type T: CO2-Gas-Filled, Subdivided Polymer Nano or Micro Structures with Reduced Thermal Conductivity

The subdivided polymers, periodic or amorphous structured nanobubble or nanoparticle assembly in this disclosure utilize the high percentage of porosity filled with air in order to reduce the thermal conductivity of the polymer materials. As the thermal conductivity of CO2 gas is ˜0.0146 wat/m·K as compared to that of air, 0.025 watt/m·K, the use of CO2 gas will result in a decrease of thermal conductivity by ˜40% of the air in the pores. Depending on the amount of porosity vs that of the polymer material, the overall thermal conductivity will be determined, desirably with at least 10% reduction in overall thermal conductivity, preferably at least 25% reduction.

According to the present disclosure, the pores in the polymer nanostructure can be filled with CO2 gas by placing the insulator material in a vacuum chamber, pumping out the air, back-filling with CO2 gas, followed by thermal annealing to help seal in the CO2 within the polymer insulator structure. The degree of leaking and sustainability of CO2 containment in the pores will depend on the nature of polymer material, structure of the polymer nanobubble and the details of structural sealing of the polymer nano structures.

### Embodiment Structure Type U: Optionally Added Low-Emission Layer to Reduce Heat Loss or Hard-Coating Layer to Improve Wear-Resistance

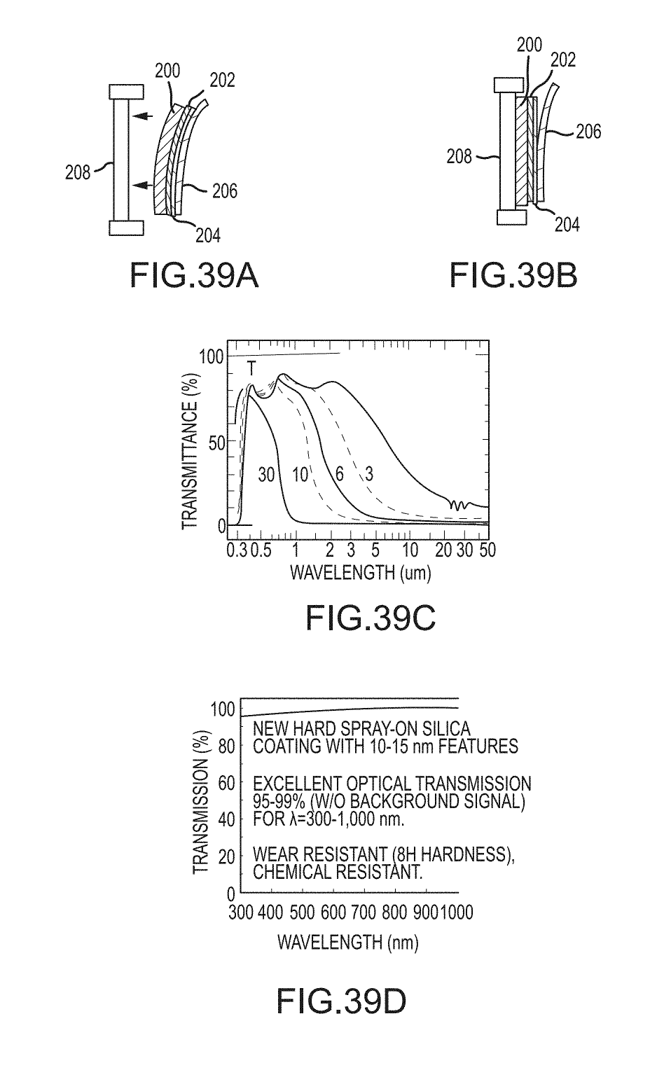

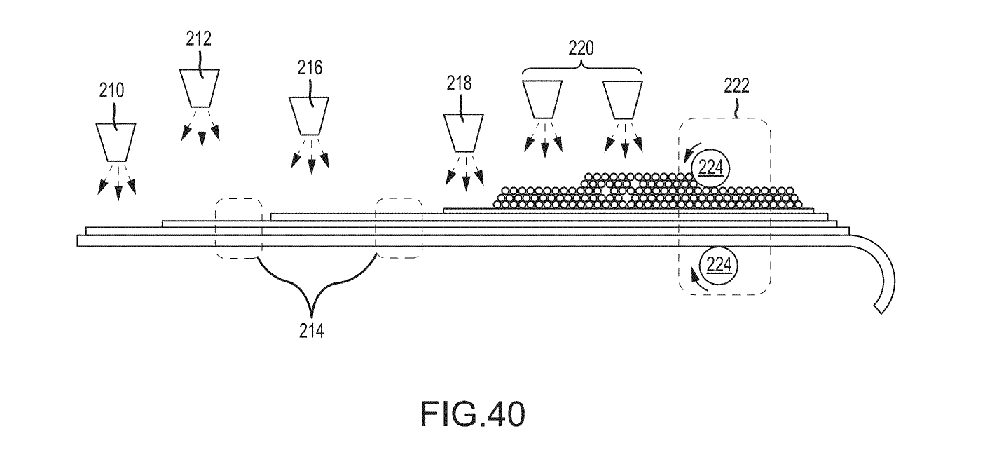

In order to further improve the thermal insulation performance of the polymer nano-bubble thermal barrier layer (200), such a layer can be additionally coated with a well-known low-emissivity material, ITO (indium tin oxide) (202, FIG. 40A) (See: Hamberg et al., Appl. Optics, (1985); G. C. Granqvist et al., Thin Solid Films, (2002)) with a general composition of ˜74% In, 18% O₂, and 8% Sn by weight. Such near-infrared (NIR) or infrared (IR)-reflecting layer can reflect the room temperature radiation back to the interior of the room in a building so that the loss of thermal energy through NIR or IR emission through the glass window is minimized. For example, approximately ˜200 nm thick ITO coating (202) can be added onto the surface of the polymer layer thermal barrier (200). Excellent IR-reflecting properties of ITO (see: Hamberg et al., Appl. Optics, (1985)) or other metal thin film based low-e coatings (FIG. 39C) can be utilized for low-e (low-emission) window panes. While the use of thin film vacuum deposition such as sputtering is not excluded, this disclosure preferably incorporates a more cost-effective method of spray coating of ITO precursor sol-gel type solution. Non-organic precursor solutions of indium and tin, such as nitrate, acetate, or isopropoxide solutions, with ethanol, succinic acid, polyvinyl alcohol as complexing agents can be utilized to obtain good quality ITO films by wet chemical methods. See: Legnani et al., Thin Solid Films, (2007); Kundu et al., Chem Phys. Lett., (2005). Organic solvents like ethylene glycol, ethanol or acetylacetone may also be employed for wet synthesis of ITO. An alternative (back-up) approach is to utilize pre-made ITO nanoparticles. See: K. Daoudi et al., Thin Solid Films, (2003); D. Gallagher et al., J. Mater. Res., (1993). These ITO nanoparticles, already crystallized, can be mixed with a transparent silica sol-gel solution and spray coated to produce a low-e layer.

In order to impart wear resistance and chemical resistance (such as against window cleaning agents), the thermal barrier layer (200) with low-e coating (202) can also be coated with a high-reliability sol-gel silica layer (204), as depicted in FIGS. 39A and 39B. About 200 nm thick silica coating (optionally also containing alumina or titania) can be employed to provide an excellent hardness of 8H and optical transparency of >95-99% (see FIG. 39D). This modified silica layer (204) demonstrated a superhydrophobic characteristics (due to the silane CH3 functionality+some surface topography) (see: VG Parale et al., J. Porous Materials, (2013)) and mechanically wear-resistant, durable properties (hardness level=8H) (FIGS. 39A, 39D).

The peelable carrier sheet (206) substrate material (e.g., ˜250 μm thick) in a spool form can be selected from common polymer materials such as polyimide (PI) sheet of Kapton (oxydiphenylene pyromellitimide), or other high temperature polymers, or metallic substrates such as inexpensive Al foil. Kapton, a polyimide film by DuPont, remains stable across a wide range of temperatures up to ˜400° C., and is utilized as thermal blankets on spacecrafts and satellites, and to protect instruments. In large quantity, polyimide (PI) is not all that expensive. The (thermal barrier+low-e layer+wear-resistant layer+carrier sheet) multi-layer structure can be constructed in a convenient and inexpensive manner by a continuous, one-series spray coating process (see FIG. 40), employing a well-known silicone bond adhesive material (e.g., MasterSil 151Med coated via T-die casting), which is known to be stable close to ˜200-250° C. The multi-layer material product is then unwound from the spool, cut and attached onto the single pane glass interior surface using a silicone adhesive (e.g., pre-coated on the nano-bubble layer surface, not shown in FIGS. 39A and 39B). The wear-resistant silica coating layer described in this disclosure contains ˜10-15 nm nanoparticle surface roughness features, optically transparent (FIG. 39D), and is superhydrophopbic (which is also helpful to reduce condensation and frosting).

The nanobubble layer (200) can have adhesive coatings on both surfaces (not shown) so that it is attachable to the low-e, ITO layer on the one side and attachable to the glass window (208) on the other side. The layer material also exhibits other important properties of being i) quite transparent due to the essentially periodic nano-dimension structures well away from the visible spectrum regime, ii) light-weight, iii) flexible and bendable, iv) wear-resistant and fire/chemical-resistant, v) soundproof due to phonon scattering at many nano-cell boundaries especially with soft polymer material basis, vi) condensation resistant due to good thermal insulation and superhydrophobic surface properties, and is vii) of low cost and highly manufacturable.

For the manufacturing of the proposed polymer nano-bubble thermal barrier material, together with a low-emission coating already incorporated, a continuous processing with multi-station operation, as illustrated in FIG. 40, is desirable as the processing step is simplified and the cost is reduced. For example, a spray coat of peelable adhesive may first be applied (210). This may be followed by a spray coat of a wear resistant, transparent silica coat (212), which is cured at a curing station (214). Then, a low-e layer may be sprayed on (216) and cured at another curing station (214). This may be followed by another adhesive layer (218). A spray coating of polymer nanospheres may then be applied (220), and any defects removed at a roller compacting and curing station (222) comprising compression rollers (224).

There are some other options/strategies in terms of processing of the thermal barrier layer. The hollow nanosphere production portion, the stacking/sintering portion, and the low-e coating portion can optionally be separated into three different operations, rather than combined as in FIG. 40.

There are many engineering uses for the nanopolymer insulator materials. Some example applications of the disclosed items for heat flow blocking include the following:

(1) Thermal insulation for building envelopes, especially glass windows: the items detailed herein, being optically transparent and highly insulating, can be lamination coated or transfer attached on glass windows, either inside or outside, to save energy loss through window glass or building walls.
(2) The thermal insulation coating can also be applied onto automobiles (glass windshield, automobile body, steering wheels, etc.), tanks, armors, especially in hot weather regions to minimize the vehicle and military transportation vehicles getting overly hot.
(3) The thermal insulator structures, according to the present disclosure, can also be used for energy saving applications for cold environment such as refrigerators, freezers, cargo ships, freight shipping by boat, truck, airplane, etc.
(4) It can also be useful for protecting and safeguarding personnel and equipment by application to clothing, machineries, batteries, supercapacitors, solar cells, electronic devices in general or other energy storage and energy generating devices or electronics to function properly at near room temperature or at low temperatures, including arctic or Antarctic environment. For cold weather or chill weather environment, a highly insulating fabrics for clothing such as underwear, shirts, sweaters or jackets will be useful to keep the wearer warmer. At too cold temperatures, electronics may not function properly, and lubricants may not be fully operational, and thermal contractions may induce mechanical stresses and complications.
(5) Apparel like underwear that can keep the wearer warm, especially in the winter weather.
(6) Outdoor electronic devices such as surveillance cameras, sensors (earthquake sensors, gas sensors, etc.), actuators, controllers, recorders, signal processors, robotic manipulators, RF functionality, Wi-Fi relay apparatus, outdoor voltage transformers. These electronics boxes can be coated with item coatings so as to keep the temperature of the electronic devices within the boxes from getting overly hot and damage the functioning of the devices.
(7) The items having superior thermal insulation properties can be patterned and locally or selectively added or coated onto fabrics or apparels so as to artificially induce surface thermal patterns modifying the heat pattern from the human body to confuse infrared heat detection of the shape of a warm-body person. Military personnel anti-detection clothing with cloaking patterned or random patterned coverage (coatings) on the fabric so as to confuse the detection such as IR detection of the presence of a person more difficult.

### Additional Embodiments

In one aspect of the present disclosure, a thermally insulating article is provided which is comprised of comprising subdivided polymer materials with thermal conductivity of less than 0.10 watt/m·K, preferably less than 0.05 watt/m·K, even more preferably less than 0.03 watt/m·K. In embodiments, the article has a dimension of subdivision in the range of 10 nm-10 μm, preferably 10 nm-2 μm, more preferably 10 nm-100 nm. In embodiments, the article has an overall materials porosity of at least 50%, preferably >60%, even more preferably >75%.

In embodiments, the polymer is selected from a list of polymethylmethacrylate (PMMA), polyethylene terephthalate (PET), polystyrene (PS), polypropylene (PP), polyester (PES), polyethylene (PR), polytetrafluoroethylene (PTFE), polydimethylsiloxane (PDMS), polyvinylidene fluoride (PVDF), polyethylene naphthalate (PEN), polybutylene terephthalate (PBT), and co-polymer thereof and any combinations thereof.

In embodiments, the polymer subdivision is in a periodic nanoscale structure, with the subdivision configuration selected from a periodic nanobubble or from an inverse nano-opal structure In embodiments, the subdivision dimension in the range of 10-100 nm.

In embodiments, the polymer subdivision is a non-periodic, AMORPHOUS ARRAY polymer nanoparticle structure. In embodiments, the subdivision configuration is selected from non-uniform diameter nanoparticle assembly or from irregular shape nanoparticle assembly structure. In embodiments, the subdivision dimension in the range of 10-100 nm.

In embodiments, the polymer subdivision is a microscale, non-periodic, AMORPHOUS ARRAY polymer particle structure. In embodiments, the subdivision configuration selected from non-uniform diameter microparticle assembly or from irregular shape microparticle assembly structure. In embodiments, the subdivision dimension in the range of 100 nm-10 um.

In embodiments, the AMORPHOUS ARRAY subdivision polymer nano structure and the polymer micro structure comprises a desired polymer particle size difference among the 90% volume of the particles in the polymer assembly structure is at least 10%, preferably at least 20%, even more preferably at least 30%. In embodiments, the porosity generated by non-uniform diameter is at least 30%, and preferably at least 50%. In embodiments, the portion of the smaller particles having a diameter less than one-half of the average particle size in the material is kept minimal, to be less than 50% volume, preferably less than 30%, even more preferably less than 15% of the total polymer nano or micro particle material.

In embodiments, the irregular shape is selected from oval, rectangle, triangular, cylindrical, tube shaped, hollow-hole-containing, wire-shaped, curved geometry, or other random shapes.

In embodiments, the subdivided polymer particles contain one or more internal pores. In embodiments, the internal pores are in the range of 1-5 μm size. In embodiments, the contribution of the internal pores is at least 5% porosity of the overall porosity of the polymer insulator material.

In embodiments, the articles described herein also have optical properties of: optical transparency of at least 70%, preferably at least 80%, even more preferably at least 90%; and optical haze of at most 10%, preferably at most 5%, even more preferably at most 2%.

In embodiments, the articles described herein also contain pores filled with CO₂ gas, with thermal conductivity value reduced by at least 10%, preferably at least 25% reduction.

In aspects of the present disclosure, environmentally degradable nano or micro subdivided polymer insulator materials are disclosed having hollow or solid polymer particles, having equi-diameter, non-uniform diameter, or irregular shape. Each of the polymer nano or micro particles separated by easily degradable or dissolvable interfacial adhesives or surfactant. In embodiments, the dissolvable or degradable interface materials selected from a list of materials such as surfactants like Pluronic P-123, Sodium dodecyl sulfate (SDS), centrimonium bromide (CTAB), adhesive coat (e.g., dextrin, honey, gelatins, polysaccharides, polyvinyl alcohol, epoxy or other adhesives), or biodegradable polymers such as polyglycolic acid (PGA), polylactic acid (PLA), poly(lactic-co-glycolic acid) (PLGA), polyhydroxy butyrate (PHB), poly-hydroxybutyrate-co-b-hydroxy valerate (PHBV), or polycaprolactones (PCL).

In embodiments, the speed of disintegration in the environment is accelerated by a factor or at least 2, preferably 5, even more preferably by a factor of 10, as compared with regular plastic material without nano or microstructure of degradation enhancing configurations.

In embodiments, the environmentally degradable nano or micro subdivided polymer insulator materials comprise hollow or solid polymer particles, having equi-diameter, non-uniform diameter, or irregular shapes. In embodiments, aggregates of polymer nano or micro particles separated by easily degradable or dissolvable interfacial adhesives or surfactant, so that the resultant disintegrated material segments are at least 1 um, preferably at least 50 μm, even more preferably at least 1 mm.

In embodiments, the dissolvable or degradable interface materials positioned only sporadically at selected interface locations spaced apart at average aggregate size of at least 1 um, preferably at least 50 um, even more preferably at least 1 mm.

In embodiments, the dissolvable or degradable interface materials are selected from a list of materials such as surfactants like Pluronic P-123, sodium dodecyl sulfate (SDS), centrimonium bromide (CTAB), adhesive coat (e.g., dextrin, honey, gelatins, Polysaccharides, polyvinyl alcohol, epoxy or other adhesives), or biodegradable polymers such as polyglycolic acid (PGA), polylactic acid (PLA), poly(lactic-co-glycolic acid) (PLGA), polyhydroxy butyrate (PHB), poly-hydroxybutyrate-co-b-hydroxy valerate (PHBV), or polycaprolactones (PCL).

In embodiments, the environmentally degradable nano or micro subdivided polymer insulator materials have thermal conductivity of less than 0.05 watt/m·K, preferably less than 0.03 watt/m·K.

In embodiments, the environmentally degradable nano or micro subdivided polymer insulator materials have optical transparency of at least 70%, preferably at least 80%, even more preferably at least 90%, together with optical haze scattering less than 10%, preferably less than 5%, even more preferably less than 2%.

In embodiments, the environmentally degradable nano or micro subdivided polymer insulator materials have UV protection or absorption coating added or chemically to stabilize the polymer chains by utilizing a stabilizer component incorporated.

In embodiments, the environmentally degradable nano or micro subdivided polymer insulator materials have wear resistant coating comprising ceramic nanoparticles.

In embodiments, the environmentally degradable nano or micro subdivided polymer insulator materials have a low-emission coating to minimize the loss of room energy by a glass window.

In embodiments, the environmentally degradable nano or micro subdivided polymer insulator materials have a multilayer lamination configuration for easy attachment onto the glass window, comprising a supportive adhesive coated carrier layer.

In other aspects of the present disclosure, methods of synthesizing solid polymer nanoparticles having spherical or irregular shapes, using emulsion synthesis, spray pyrolysis, template method and other methods using a selected mixture of monomer, polymer, water, alcohol, solvent, polymerization catalyst, and surfactant, are disclosed.

In other aspects of the present disclosure, methods of preparing hollow polymer nanoparticles using emulsion synthesis with sacrificial templates of solid or hollow silica nanospheres, solid or hollow polymer nanospheres, liquid core, spray pyrolysis, solvent freeze and drying-removal approach to form internal voids within polymer particle matrix, using a selected mixture of monomer, polymer, water, alcohol, solvent, polymerization catalyst, and surfactant, are disclosed.

In other aspects of the present disclosure, methods of forming a periodically arranged polymer nanobubble structured thermal insulator having a thermal conductivity of less than 0.10 watt/m·K, preferably less than 0.05 watt/m·K, by stacking hollow polymer nanospheres and sinter-bonding or adhesive-bonding are disclosed.

In other aspects of the present disclosure, methods of forming polymer inverse nano-opal structured thermal insulator having a thermal conductivity of less than 0.10 watt/m·K, preferably less than 0.05 watt/m·K, by preparing a first polymer nanospheres having mono-disperse particle diameter, stacking the solid polymer nanoparticles into multilayers, inserting a second polymer in liquid form, thermally or optically curing the inserted second polymer, and dissolving away the core solid polymer nanoparticles so as to create voids and form inverse nano-opal structure, are disclosed.

In other aspects of the present disclosure, methods of polymer nanostructure comprising porosity by phase decomposing a diblock or triblock copolymer, and dissolving away one of the phases to form pores within a matrix polymer, are disclosed.

In other aspects of the present disclosure, methods of preparing a layer of thermally insulating polymer layer material having thermal conductivity of at most 0.10 watt/m·K, preferably 0.05 watt/m·K, by stacking of solid polymer nanoparticles or hollow polymer nanospheres into a layer material utilizing one or more of the stacking approaches selected from a list of procedures are disclosed. The above-mentioned list of procedures comprise: i) Centrifugal Drying Stacking method, ii) Continuous Dip Coating Stacking, iii) Roller Compacting Stacking, iv) “Discrete Electro Spray” (DES), stationary or continuous process, using hydrophilic or hydrophobic island array to form nano droplets or nanoparticles, and a continuous “Electro-Stacking” using electrical-field-actuated stacking of nano particles, v) Surfactant-assisted evaporation for self-assembly dense stacking, vi) Air bubble stacking technique, and vii) Electrolytic deposition stacking of charged polymer nanoparticles.

In another aspect of the present disclosure, a multi-station, continuous manufacturing is disclosed of polymer nano-bubble thermal insulator layer with low-emission coating, wear resistant coating, adhesive coating also incorporated using one-series operation, including spray coating stations, curing stations and winding up into a roll configuration at the take-up wheel.

In other aspects of the present disclosure, the articles described herein can be used for various applications including, but not limited to: (1) Thermal insulation for building envelopes, especially glass windows; the disclosed materials, being optically transparent and highly insulating, can be lamination coated or transfer attached on glass windows, either inside or outside, to save energy loss through window glass or building walls. (2) The thermal insulation coating can also be applied onto automobiles (glass windshield, automobile body, steering wheels, etc.), tanks, armors (cannons) especially in hot weather regions to minimize the vehicle and military transportation vehicles getting overly hot. (3) The thermal insulator structures, according to the present disclosure, can also be used for energy saving applications for cold environment such as refrigerators, freezers, cargo ships, freight shipping by boat, truck, airplane, etc. (4) It can also be useful for protecting and safeguarding personnel and equipment by application to clothing, machineries, batteries, supercapacitors, solar cells, electronic devices in general or other energy storage and energy generating devices or electronics to function properly at near room temperature or at low temperatures. For cold weather or chill weather environment, a highly insulating fabrics for clothing such as underwear, shirts, sweaters or jackets will be useful to keep the wearer warmer. At too cold temperatures, electronics may not function properly, and lubricants may not be fully operational, and thermal contractions may induce mechanical stresses and complications. (5) Apparel like underwear that can keep the wearer warm, especially in the winter weather. (6) Outdoor electronic devices such as surveillance cameras, sensors (earthquake sensors, gas sensors, etc.), actuators, controllers, recorders, signal processors, robotic manipulators, RF functionality, Wi-Fi relay apparatus, outdoor voltage transformers. These electronics boxes can be coated with item coatings so as to keep the temperature of the electronic devices within the boxes from getting overly hot and damage the functioning of the devices. (7) The items having superior thermal insulation properties can be patterned and locally or selectively added or coated onto fabrics or apparels so as to artificially induce surface thermal patterns modifying the heat pattern from the human body to confuse infrared heat detection of the shape of a warm-body person. Military personnel anti-detection clothing with cloaking patterned or random patterned coverage (coatings) on the fabric so as to confuse the detection such as IR detection of the presence of a person more difficult.

It is to be understood that the above-described embodiments are illustrative of only a few of the many possible specific embodiments which can represent applications of the invention. Numerous and various other arrangements can be made without departing from the spirit and scope of the invention. For example, the thermally highly insulating polymer nanoparticles or aggregate of nanoparticles in microscale or in macroscale can also be mixed with a liquid carrier so as to prepare a paint-like material that can be coated onto any surface for thermal insulation enhancement.

What is claimed is:

1. A structure comprising non-periodically arranged, amorphously distributed polymer nanoparticles, wherein the structure comprises no more than about 70% by volume of the nanoparticles with the remaining volume occupied by a gas, and wherein the structure has a thermal conductivity of less than about 0.10 watt/mK.

2. The structure of claim 1, wherein the gas occupying the remaining volume is selected from one or more of air, N₂, CO₂, or argon gas.

3. The structure of claim 1, wherein the structure has a thermal conductivity of less than about 0.05 watt/mK.

4. The structure of claim 1, wherein the structure has a thermal conductivity of less than about 0.03 watt/mK.

5. The structure of claim 1, wherein the structure comprises no more than about 55% by volume of the nanoparticles.

6. The structure of claim 1, wherein the nanoparticles comprise nanospheres having a particle size distribution with an average diameter of less than about 1 μm.

7. The structure of claim 6, wherein the nanoparticles comprise nanospheres having an average diameter of about 10 nm to about 100 nm.

8. The structure of claim 7, wherein the nanospheres comprise hollow interiors comprising at least 20% of the total volume of the structure.

9. The structure of claim 8, wherein the hollow interiors are filled with a gas selected from one of more of air, nitrogen, CO₂ or argon gas, and wherein the nanospheres have average diameters of about 10 nm to about 100 nm.

10. The structure of claim 6, wherein the nanospheres are stacked and either sinter-bonded or adhesive-bonded together.

11. The structure of claim 6, wherein the particle size distribution comprises a diameter variance of at least about 30% amongst about 90% of the nanospheres.

12. The structure of claim 6, wherein nanospheres having diameters less than about one-half the average diameter comprise less than about 15% of the nanospheres.

13. The structure of claim 1, wherein the nanoparticles are irregularly shaped.

14. The structure of claim 13, wherein the nanoparticles comprise an elongated shape having a longest dimension to a shortest dimension aspect ratio in the range of from about 2 to about 5.

15. The structure of claim 14, wherein nanoparticles of elongated shape are made elongated by using a solvent trapping method within the polymer nanoparticles.

16. The structure of claim 1, wherein the polymer is selected from the group consisting of polymethylmethacrylate (PMMA), polyethylene terephthalate (PET), polystyrene (PS), polypropylene (PP), polyester (PES), polyethylene (PR), polytetrafluoroethylene (PTFE), polydimethylsiloxane (PDMS), polyvinylidene fluoride (PVDF), polyethylene naphthalate (PEN), polybutylene terephthalate (PBT), co-polymers thereof, and mixtures thereof.

17. The structure of claim 1, wherein the structure has an optical transparency of at least about 80%.

18. The structure of claim 1, wherein the structure has an optical haze property of at most about 2%.

19. The structure of claim 1, wherein the nanoparticles comprise one or more internal pores within each nanoparticle, each internal pore having a size range of about 1 nm to about 1 μm.

20. The structure of claim 19, wherein the internal pores within each nanoparticle have a size range of about 1 nm to about 50 nm.

21. The structure of claim 20, wherein the internal pores are made by using a solvent trapping method within the polymer nanoparticles.

22. The structure of claim 20, wherein the internal pores are gas-filled, and wherein the structure comprising gas-filled pores has at least a 10% lower thermal conductivity compared to a corresponding structure comprising air-filled pores.

23. The structure of claim 22, wherein the gas is selected from one of more of air, nitrogen, CO₂ gas or argon gas.

24. The structure of claim 6, wherein the polymer comprises polystyrene, the nanospheres vary in diameter from about 30 nm to about 70 nm, and the structure comprises no more than from about 40% to about 50% by volume of nanospheres, and wherein a portion of the structure is at least 1 mm thick, and is optically transparent.

25. The structure of claim 1, further comprising a biodegradable or dissolvable polymer insulator material.

26. The structure of claim 25, wherein the biodegradable or dissolvable polymer insulator material is selected from the group consisting of materials Pluronic P-123, sodium dodecyl sulfate (SDS), centrimonium bromide (CTAB), dextrin, honey, gelatin, polysaccharides, polyvinyl alcohol, epoxy, polyglycolic acid (PGA), polylactic acid (PLA), poly(lactic-co-glycolic acid) (PLGA), polyhydroxy butyrate (PHB), poly-hydroxybutyrate-co-b-hydroxy valerate (PHBV), polycaprolactones (PCL), and mixtures thereof.

27. The structure of claim 25, wherein the nanoparticles are distributed in aggregates that are separated from each other by the biodegradable or dissolvable polymer insulator material.

28. The structure of claim 1, wherein the nanoparticles are prepared by emulsion synthesis, spray pyrolysis, or a template method.

29. The structure of claim 1, wherein the nanoparticles are stacked into stacked layers by centrifugal drying stacking, continuous spray coating, dip coating stacking, roller compacting stacking, discrete electro spray (DES), electro-stacking, surfactant-assisted evaporation for self-assembly dense stacking, air bubble stacking technique, or electrolytic deposition stacking.

30. A thermally insulating article of manufacture comprising:
the structure of claim 1; and
a UV protection coating, a UV absorption coating, a low-emission coating, a wear-resistant coating, or an adhesive coating.
